(19) United States
(12) Patent Application Publication
(10) Pub. No.: US 2025/0296330 A1
(43) Pub. Date: Sep. 25, 2025

(54) Liquid Ejecting Head And Liquid Ejecting Apparatus

(71) Applicant: SEIKO EPSON CORPORATION, Tokyo (JP)

(72) Inventors: Hiroyuki HAGIWARA, Matsumoto (JP); Shun KATSUIE, Matsumoto (JP)

(21) Appl. No.: 19/086,227

(22) Filed: Mar. 21, 2025

(30) Foreign Application Priority Data
Mar. 22, 2024 (JP) 2024-047362

(51) Int. Cl. B41J 2/14

(52) U.S. Cl. CPC B41J 2/14233; B41J 2202/12

(57) ABSTRACT

A liquid ejecting head includes a first head chip including a first nozzle group and a first common liquid chamber portion communicating with the first nozzle group, a second head chip including a second nozzle group and a second common liquid chamber portion communicating with the second nozzle group, and a flow path structure body including a plurality of flow path substrates stacked in a first direction, and including a first flow path having a first common portion that communicates with the first common liquid chamber portion and the second common liquid chamber portion and extends in a second direction perpendicular to the first direction, and a first flexible member defining a portion of the first common portion.

The present application is based on, and claims priority from JP Application Serial Number 2024-047362, filed Mar. 22, 2024, the disclosure of which is hereby incorporated by reference herein in its entirety.

### BACKGROUND

### 1. Technical Field

The present disclosure relates to a liquid ejecting head that ejects a liquid from a nozzle and a liquid ejecting apparatus including the liquid ejecting head, and particularly to an ink jet recording head that ejects an ink as the liquid and an ink jet recording apparatus.

### 2. Related Art

A liquid ejecting apparatus represented by an ink jet recording apparatus such as an ink jet printer or a plotter includes a liquid ejecting head that ejects a liquid from a plurality of nozzles, and a flow path member in which a flow path for supplying the liquid to the liquid ejecting head is formed.

For example, JP-A-2020-142378 discloses a configuration in which a liquid ejecting head includes a head chip having a first nozzle group and a first common liquid chamber portion communicating with the first nozzle group, a head chip having a second nozzle group and a second common liquid chamber portion communicating with the second nozzle group, and a flow path structure body provided with a flow path having a common portion communicating with the first common liquid chamber portion and the second common liquid chamber portion.

However, since the first nozzle group and the second nozzle group communicate with each other via the common liquid chamber portion, there is a concern that the negative pressure generated when droplets are ejected from nozzles of one nozzle group of the first nozzle group and the second nozzle group acts on another nozzle group, and ejection failure occurs in the other nozzle group.

### SUMMARY

According to an aspect of the present disclosure, a liquid ejecting head includes a first head chip including a first nozzle group and a first common liquid chamber portion communicating with the first nozzle group, a second head chip including a second nozzle group and a second common liquid chamber portion communicating with the second nozzle group, and a flow path structure body including a plurality of flow path substrates stacked in a first direction, and including a first flow path having a first common portion that communicates with the first common liquid chamber portion and the second common liquid chamber portion and extends in a second direction perpendicular to the first direction, and a first flexible member defining a portion of the first common portion.

According to another aspect of the present disclosure, a liquid ejecting apparatus includes the liquid ejecting head according to the above aspect, and a liquid storage portion that supplies a liquid to the liquid ejecting head.

### BRIEF DESCRIPTION OF THE DRAWINGS

FIG. 1 is a view illustrating a schematic configuration of a liquid ejecting apparatus according to a first embodiment.

FIG. 2 is a perspective view of a liquid ejecting head according to the first embodiment.

FIG. 3 is a plan view of the liquid ejecting head according to the first embodiment.

FIG. 4 is a cross-sectional view of the liquid ejecting head according to the first embodiment.

FIG. 5 is a cross-sectional view of a head chip according to the first embodiment.

FIG. 6 is a plan view of the head chip according to the first embodiment.

FIG. 7 is a view illustrating a schematic configuration of a flow path of the liquid ejecting apparatus according to the first embodiment.

FIG. 8 is a cross-sectional view of a flow path member according to the first embodiment.

FIG. 9 is a plan view of a flow path substrate according to the first embodiment.

FIG. 10 is a plan view of a flow path substrate according to the first embodiment.

FIG. 11 is a plan view of a flow path substrate according to the first embodiment.

FIG. 12 is a cross-sectional view of the flow path member according to the first embodiment.

FIG. 13 is a cross-sectional view of the flow path member according to the first embodiment.

FIG. 14 is a cross-sectional view illustrating a flow path member according to a second embodiment.

FIG. 15 is a plan view of a flow path substrate according to the second embodiment.

FIG. 16 is a plan view of a flow path substrate according to the second embodiment.

FIG. 17 is a plan view of a flow path substrate according to the second embodiment.

FIG. 18 is a cross-sectional view illustrating a flow path member according to a third embodiment.

FIG. 19 is a plan view of a flow path substrate according to the third embodiment.

FIG. 20 is a plan view of a flow path substrate according to the third embodiment.

FIG. 21 is a plan view of a flow path substrate according to the third embodiment.

FIG. 22 is a cross-sectional view illustrating a flow path member according to a fourth embodiment.

FIG. 23 is a cross-sectional view illustrating a flow path member according to a fifth embodiment.

FIG. 24 is a plan view of a flow path substrate according to the fifth embodiment.

FIG. 25 is a plan view of a flow path substrate according to the fifth embodiment.

FIG. 26 is a plan view of a flow path substrate according to the fifth embodiment.

### DESCRIPTION OF EMBODIMENTS

Hereinafter, the present disclosure will be described in detail based on embodiments. However, the following description illustrates an aspect of the present disclosure, and can be freely changed within the scope of the present disclosure. Those having the same reference signs in each of the drawings indicate the same members, and the description thereof is omitted as appropriate. In each of the drawings, X, Y, and Z represent three spatial axes perpendicular to each other. In the present specification, directions along these axes are set as an X-direction, a Y-direction, and a Z-direction. A direction where the arrow in each of the drawings is directed is a positive (+) direction, and a direction opposite to the arrow is a negative (−) direction. In addition, the Z direction indicates a vertical direction, the +Z direction indicates a vertically downward direction, and the −Z direction indicates a vertically upward direction. Furthermore, the directions of three spatial axes that do not limit the positive direction and the negative direction will be described as an X-axis direction, a Y-axis direction, and a Z-axis direction.

### First Embodiment

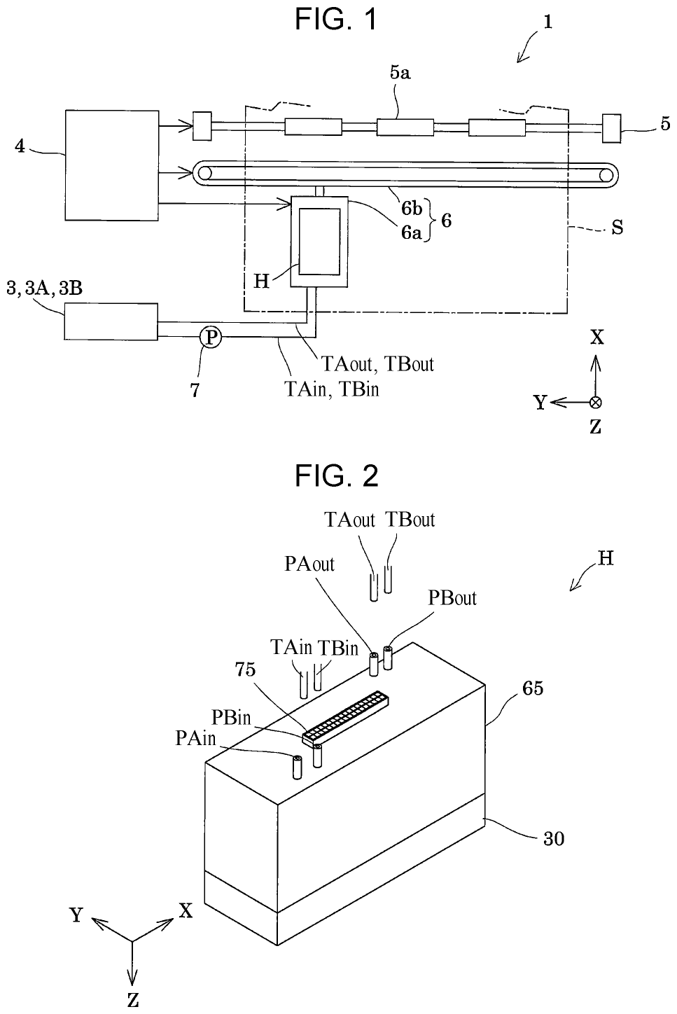

FIG. 1 is a view illustrating a schematic configuration of a liquid ejecting apparatus 1 according to the present disclosure.

As illustrated in the drawing, the liquid ejecting apparatus 1 is a so-called serial printer that includes a liquid ejecting head H, and performs printing by ejecting, which is also referred to as discharging, a liquid from the liquid ejecting head H toward a medium S in the +Z direction while transporting the medium S in the X-axis direction and reciprocating the liquid ejecting head H in the Y-axis direction. As the medium S, any material such as a resin film or cloth can be used in addition to recording paper.

The liquid ejecting apparatus 1 includes a liquid ejecting head H, a liquid storage portion 3, a controller 4, a transport mechanism 5 that feeds out a medium S, and a moving mechanism 6.

The liquid ejecting head H ejects a liquid supplied from the liquid storage portion 3 as droplets in the +Z direction.

The liquid storage portion 3 stores a liquid ejected from the liquid ejecting head H. Examples of the liquid storage portion 3 include a cartridge that can be attached to and detached from the liquid ejecting apparatus 1, a bag-shaped ink pack formed of a flexible film, an ink tank that can be refilled with ink, and the like. The liquid storage portion 3 includes a first liquid container 3A and a second liquid container 3B. A first ink is stored in the first liquid container 3A, and a second ink is stored in the second liquid container 3B. The first ink and the second ink are, for example, inks having different colors, components, or the like. The first ink and the second ink may be the same type of ink.

A supply tube TAin and a discharge tube TAout are coupled to the first liquid container 3A. A supply tube TBin and a discharge tube TBout are coupled to the second liquid container 3B. The supply tube TAin, the discharge tube TAout, the supply tube TBin, and the discharge tube TBout are referred to as a tube when not distinguished.

The supply tube TAin and the supply tube TBin are tubes for supplying the first ink of the first liquid container 3A and the second ink of the second liquid container 3B, which are pressurized to predetermined pressure by a pump 7, to the liquid ejecting head H. The discharge tube TAout and the discharge tube TBout are tubes for collecting the first ink and the second ink collected from the liquid ejecting head H to the first liquid container 3A and the second liquid container 3B, respectively.

Although not particularly illustrated, the liquid storage portion 3 may be divided into a main tank and a sub-tank. The sub-tank may be coupled to the liquid ejecting head H, and may be configured to be refilled with a liquid consumed by ejecting the droplets from the liquid ejecting head H, from the main tank.

The controller 4 includes, for example, a control device such as a central processing unit (CPU) or a field programmable gate array (FPGA), and a storage device such as a semiconductor memory. The controller 4 also includes a power supply device that supplies power supplied from an external power supply such as a commercial power supply to each element of the liquid ejecting apparatus 1. The controller 4 is electrically coupled to the liquid ejecting head H via an external wire (not illustrated). The controller 4 comprehensively controls each element of the liquid ejecting apparatus 1 by the control device executing a program stored in the storage device.

The transport mechanism 5 transports the medium S in the X-axis direction, and includes, for example, a transport roller 5a that is rotated by a transport motor that is driven and controlled by the controller 4.

The moving mechanism 6 is a mechanism for reciprocating the liquid ejecting head H in the Y-axis direction, and includes a holding body 6a that holds the liquid ejecting head H and a transport belt 6b that is an endless belt erected along the Y-axis direction. The controller 4 rotates the transport belt 6b by controlling the drive of a transport motor (not illustrated) to reciprocate the liquid ejecting head H in the Y-axis direction together with the holding body 6a fixed to the transport belt 6b. The liquid storage portion 3 can also be mounted on the holding body 6a together with the liquid ejecting head H. The holding body 6a holds one liquid ejecting head H, but the holding body 6a may hold two or more liquid ejecting heads H.

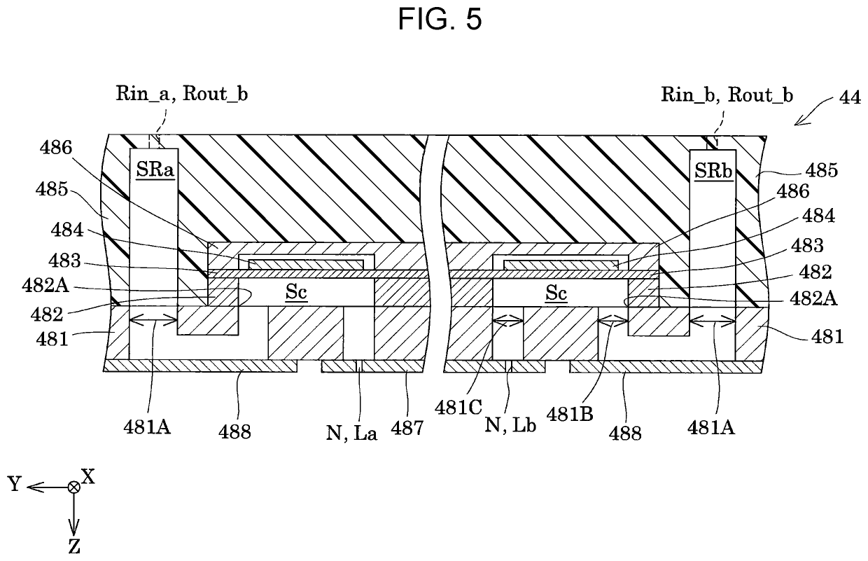

Under the control of the controller 4, the liquid ejecting head H performs a discharge operation of discharging the ink supplied from the liquid storage portion 3 as droplets from each of a plurality of nozzles N, which see FIG. 5, in the +Z direction. The controller 4 functions as a discharge controller that controls discharge of the ink by the liquid ejecting head H. The discharge operation by the liquid ejecting head H is performed in parallel with the transport of the medium S in the X-axis direction by the transport mechanism 5 and the reciprocating movement of the liquid ejecting head H in the Y-axis direction by the moving mechanism 6, so that so-called printing in which the ink is applied to the medium S is performed.

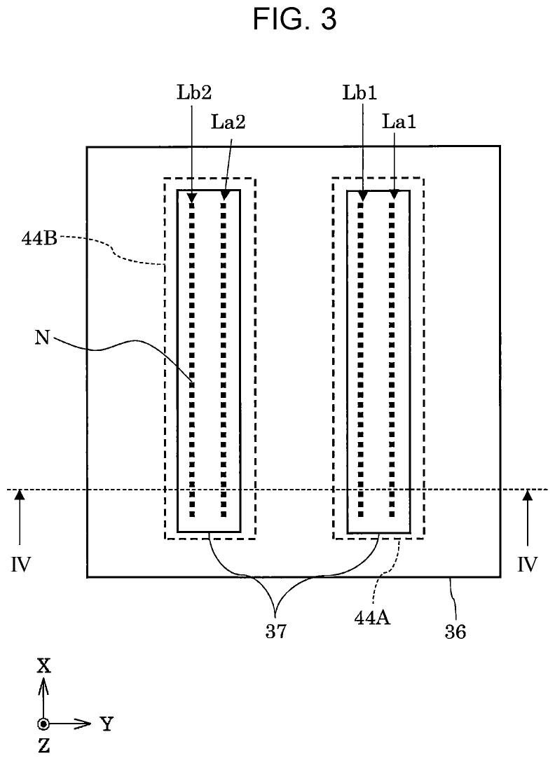

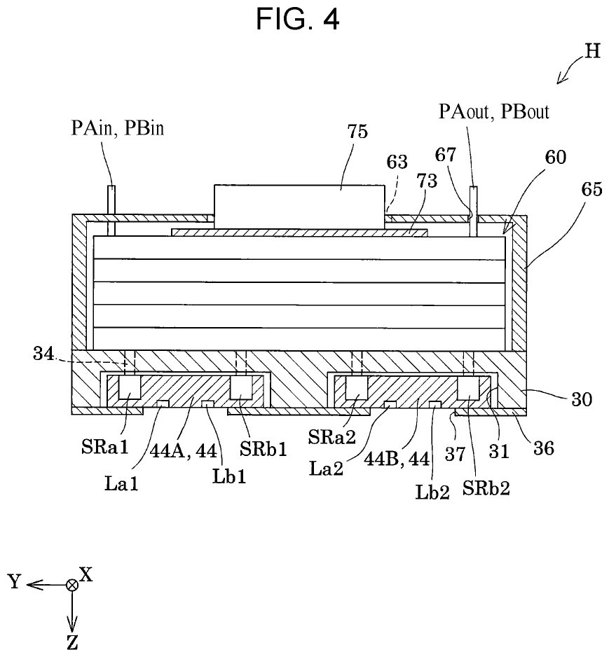

FIG. 2 is a perspective view of the liquid ejecting head H according to the first embodiment. FIG. 3 is a plan view of the liquid ejecting head H when viewed in the −Z direction. FIG. 4 is a cross-sectional view taken along line IV-IV in FIG. 3.

As illustrated in FIGS. 2 to 4, the liquid ejecting head H includes a plurality of head chips 44 provided with nozzles N for discharging ink droplets, a holder 30 that holds the head chips 44, a flow path member 60 that supplies an ink to the head chips 44, a connector 75 to which a wire for transmitting and receiving a control signal or the like to and from the head chips 44 is coupled, and a cover member 65 that accommodates the flow path member 60 therein. In the present embodiment, one liquid ejecting head H includes two head chips 44. The two head chips 44 are disposed to be arranged in the Y-axis direction. The number of head chips 44 provided in one liquid ejecting head H may be three or more.

In the present embodiment, among the two head chips 44 arranged side by side in the Y-axis direction, one head chip 44 located in the +Y direction with respect to another head chip 44 is referred to as a head chip 44A, and the other head chip 44 located in the −Y direction with respect to the head chip 44A is referred to as a head chip 44B. When the head chips 44A and 44B are not distinguished, the head chips 44A and 44B are referred to as a head chip 44.

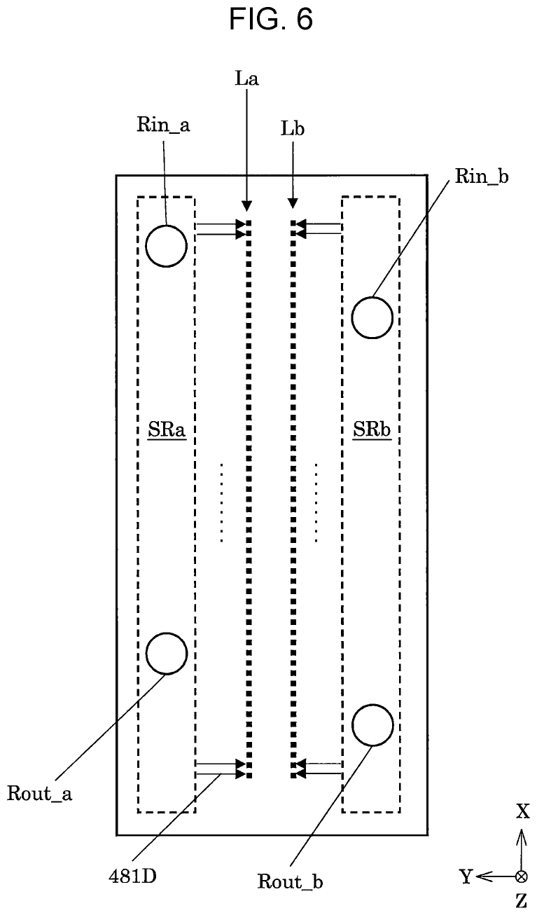

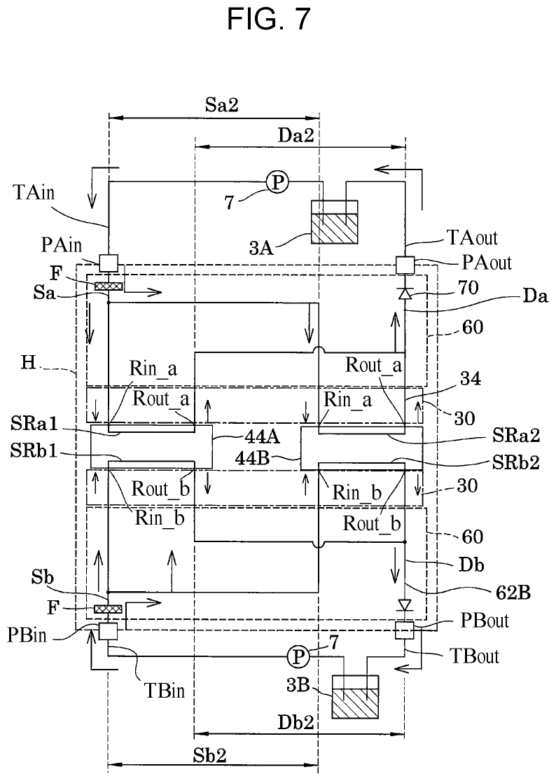

FIG. 5 is a cross-sectional view of the head chip 44 according to the first embodiment. FIG. 6 is a plan view of the head chip 44 when viewed in the +Z direction. FIG. 7 is a view illustrating a schematic configuration of a flow path of the liquid ejecting apparatus 1. Each direction of the head chip 44 will be described based on directions when mounted on the liquid ejecting head H, that is, the X-axis direction, the Y-axis direction, and the Z-axis direction. In the following description of the configuration common to the head chips 44A and 44B, the head chip 44 will be described, but each of the specific configurations of the head chips 44A and 44B will be described as the head chips 44A and 44B.

As illustrated in FIG. 5, the head chip 44 in the present embodiment is a structure body in which a pressure chamber substrate 482, a diaphragm 483, a piezoelectric actuator 484, a case portion 485, and a protective substrate 486 are disposed in the −Z direction of a flow path formation substrate 481, and a nozzle plate 487 and a head chip compliance substrate 488 are disposed on the +Z direction side of the flow path formation substrate 481.

The flow path formation substrate 481, the pressure chamber substrate 482, and the nozzle plate 487 are formed of, for example, a silicon flat plate material, and the case portion 485 is formed, for example, by injection molding of a resin material. The plurality of nozzles N are formed at the nozzle plate 487. The surface of the nozzle plate 487 opposite to the flow path formation substrate 481 is a nozzle surface.

The flow path formation substrate 481 is formed with an opening portion 481A, a communication flow path 481B which is a throttle flow path, and a communication flow path 481C. The communication flow path 481B and the communication flow path 481C are through holes formed for each nozzle N, and the opening portion 481A is a continuous opening over the plurality of nozzles N. The head chip compliance substrate 488 is made of a flat plate material that is installed on the surface of the flow path formation substrate 481 opposite to the pressure chamber substrate 482 and closes the opening portion 481A. The pressure fluctuation in the opening portion 481A is absorbed by the head chip compliance substrate 488 being flexibly deformed.

The case portion 485 is formed with a common liquid chamber SR that communicates with the opening portion 481A of the flow path formation substrate 481. As illustrated in FIG. 6, the common liquid chamber SR is a space for storing the ink supplied to the plurality of nozzles N, and is continuously provided over the plurality of nozzles N. As illustrated in FIGS. 6 and 7, the case portion 485 is provided with an introduction port Rin through which the ink is supplied to the common liquid chamber SR from the upstream, and a discharge port Rout through which the ink is discharged from the common liquid chamber SR to the downstream. Although details will be described later, the introduction port Rin is coupled to supply path coupling portions PAin and PBin of the flow path member 60 via a first supply path Sa and a second supply path Sb, and the discharge port Rout is coupled to discharge path coupling portions PAout and PBout of the flow path member 60 via a first discharge path Da and a second discharge path Db.

In the present embodiment, as illustrated in FIG. 3, the head chip 44 is provided with a nozzle row in which the nozzles N are arranged side by side along the X-axis direction. The head chip 44 is provided with a plurality of nozzle rows in which the nozzles N are arranged side by side in the X-axis direction in the Y-axis direction, and in the present embodiment, two nozzle rows are provided. In the present embodiment, among the two nozzle rows provided at one head chip 44, one disposed in the +Y direction is referred to as a nozzle row La, and the other disposed in the −Y direction is referred to as a nozzle row Lb. In the present embodiment, the nozzle row La and the nozzle row Lb are collectively referred to as a nozzle row L. In these two rows of the nozzle row La and the nozzle row Lb, the positions of the respective nozzles N may be the same in the +X direction, that is, may be disposed at positions overlapping each other when viewed in the +Y direction. The other nozzle row Lb may be disposed to be shifted from one nozzle row La in the +X direction by half a pitch of the nozzle N. In the present embodiment, the nozzle row La of the head chip 44A may be referred to as a nozzle row La1, the nozzle row Lb of the head chip 44A may be referred to as a nozzle row Lb1, the nozzle row La of the head chip 44B may be referred to as a nozzle row La2, and the nozzle row Lb of the head chip 44B may be referred to as a nozzle row Lb2.

The common liquid chamber SR is provided for each of the nozzle row La and the nozzle row Lb. That is, one head chip 44 is provided with two common liquid chambers SR. In the present embodiment, the common liquid chamber SR that communicates with a plurality of nozzles N constituting the nozzle row La1 may be referred to as a common liquid chamber SRa1, the common liquid chamber SR that communicates with a plurality of nozzles N constituting the nozzle row Lb1 may be referred to as a common liquid chamber SRb1, the common liquid chamber SR that communicates with a plurality of nozzles N constituting the nozzle row La2 may be referred to as a common liquid chamber SRa2, and the common liquid chamber SR that communicates with a plurality of nozzles N constituting the nozzle row Lb2 may be referred to as a common liquid chamber SRb2. When the common liquid chamber SRa1 and the common liquid chamber SRa2 are not distinguished, the common liquid chamber SR communicating with the nozzle row La is referred to as a common liquid chamber SRa. When the common liquid chamber SRb1 and the common liquid chamber SRb2 are not distinguished, the common liquid chamber SR communicating with the nozzle row Lb is referred to as a common liquid chamber SRb.

As illustrated in FIG. 5, the pressure chamber substrate 482 of the head chip 44 is formed with an opening portion 482A for each nozzle N. The diaphragm 483 is an elastically deformable flat plate material installed on the surface of the pressure chamber substrate 482 opposite to the flow path formation substrate 481. A space interposed between the diaphragm 483 and the flow path formation substrate 481 on the inside of each opening portion 482A of the pressure chamber substrate 482 functions as a pressure chamber SC filled with the ink supplied from the common liquid chamber SR via the communication flow path 481B. Each pressure chamber SC communicates with the nozzle N via the communication flow path 481C of the flow path formation substrate 481. The communication flow path 481B, the pressure chamber SC, and the communication flow path 481C constitute an individual flow path 481D, which see FIG. 6, that causes the common liquid chamber SR to individually communicate with one nozzle N.

The piezoelectric actuator 484 is formed for each nozzle N on the surface of the diaphragm 483 opposite to the pressure chamber substrate 482. Each piezoelectric actuator 484 is also called a piezoelectric element, and is a drive element in which a piezoelectric body is interposed between electrodes facing each other. The piezoelectric actuator 484 deforms based on the driving signal to vibrate the diaphragm 483 and fluctuate the pressure of the ink in the pressure chamber SC, and accordingly, the ink in the pressure chamber SC is ejected from the nozzle N. The protective substrate 486 also protects the plurality of piezoelectric actuators 484.

As illustrated in FIG. 4, a plurality of such head chips 44 are provided in one liquid ejecting head H, and in the present embodiment, two head chips 44 are provided. The two head chips 44 are held by the common holder 30 of the liquid ejecting head H.

The holder 30 has an accommodation portion 31 having a recessed shape that is open on a surface facing the +Z direction. The head chip 44 is accommodated in the accommodation portion 31. The accommodation portion 31 is provided independently for each head chip 44.

The holder 30 is provided with a plurality of communication paths 34 for circulating the ink between the head chip 44 and the flow path member 60. One end of the communication path 34 is open on the bottom surface of the accommodation portion 31, that is, the surface in the −Z direction in the accommodation portion 31, and communicates with each of the two introduction ports Rin and the two discharge ports Rout of the head chip 44. Therefore, four communication paths 34 are provided for one head chip 44. The other end of the communication path 34 is open on the surface of the holder 30 facing the −Z direction, and communicates with the first supply path Sa, the second supply path Sb, the first discharge path Da, and the second discharge path Db of the flow path member 60, which will be described in detail later. Here, as illustrated in FIGS. 4 to 7, each introduction port Rin communicating with each common liquid chamber SRa of the two head chips 44 is referred to as an introduction port Rin_a, each discharge port Rout communicating with each common liquid chamber SRa of the two head chips 44 is referred to as a discharge port Rout_a, each introduction port Rin communicating with each common liquid chamber SRb of the two head chips 44 is referred to as an introduction port Rin_b, and each discharge port Rout communicating with each common liquid chamber SRb of the two head chips 44 is referred to as a discharge port Rout_b.

A fixing plate 36 is fixed to the surface of the holder 30 facing the +Z direction. The fixing plate 36 is made of a metal plate such as stainless steel, and has a size that covers an opening of the accommodation portion 31. The fixing plate 36 is a common member fixed to the surface of the plurality of head chips 44 facing the +Z direction. The fixing plate 36 is provided with an exposure opening portion 37 that exposes the nozzle N of the head chip 44 in the +Z direction, independently for each head chip 44. The ink is discharged from the nozzle N exposed from the exposure opening portion 37 in the +Z direction.

In other words, the head chip 44 is accommodated in a space formed by the accommodation portion 31 and the fixing plate 36, and the nozzle N is exposed from the exposure opening portion 37. The accommodation portion 31 may be provided in common across the plurality of head chips 44.

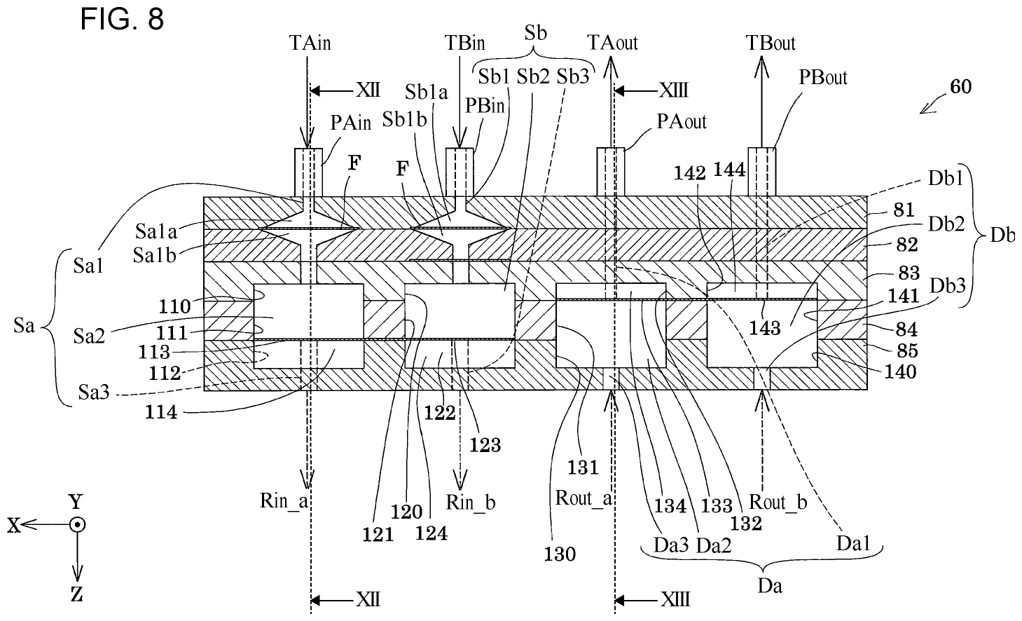

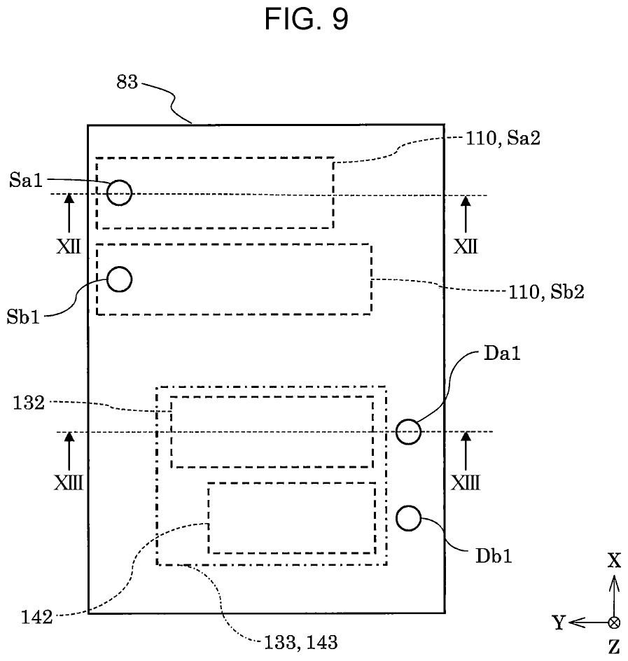

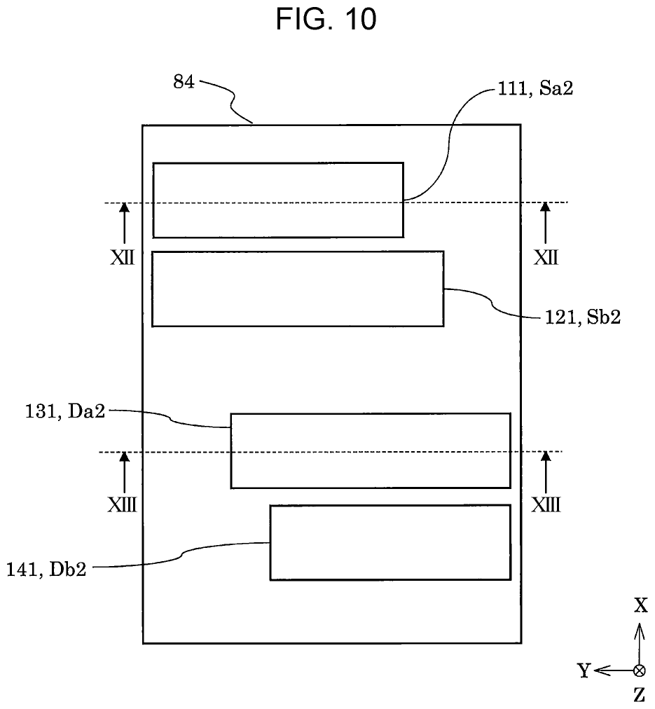

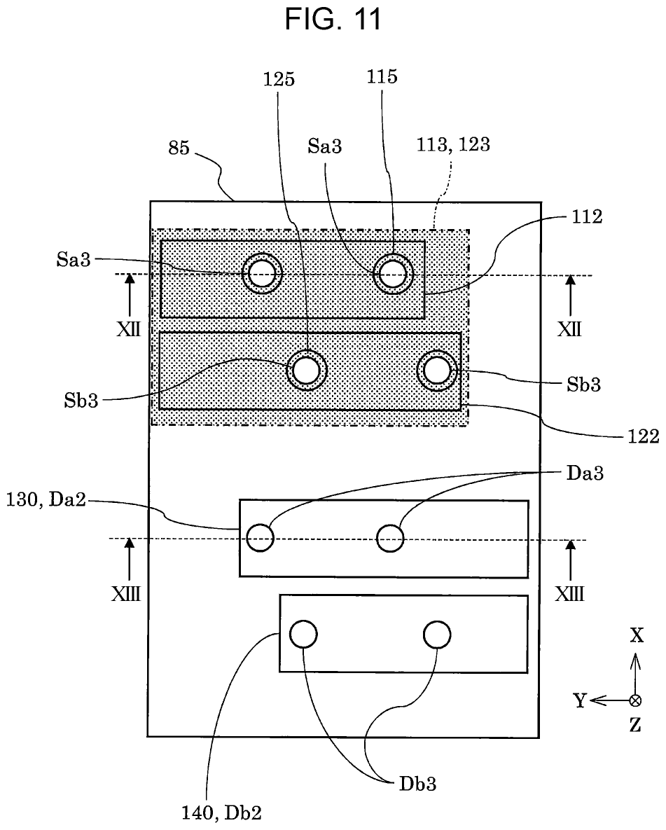

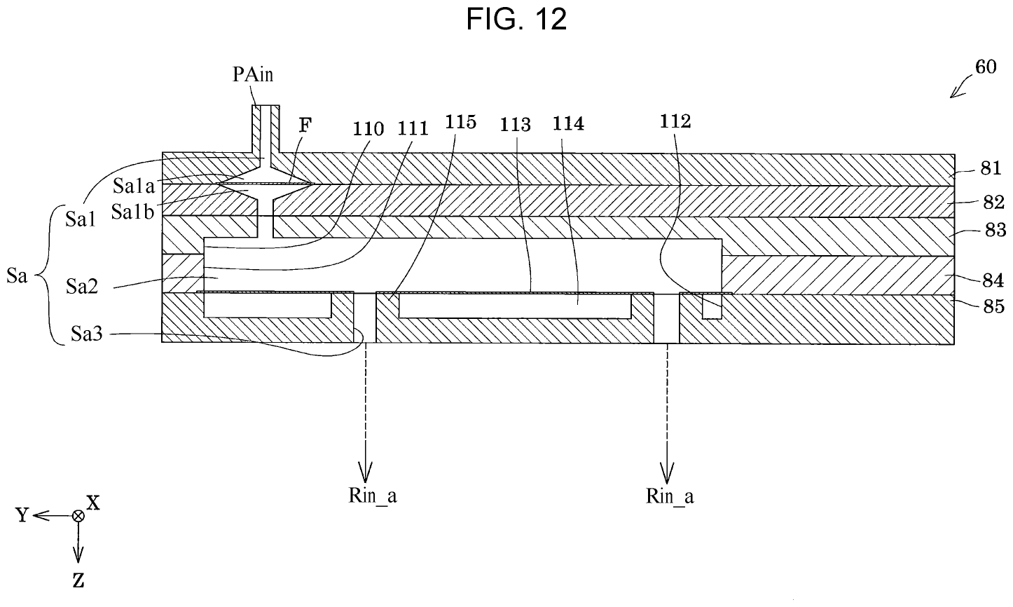

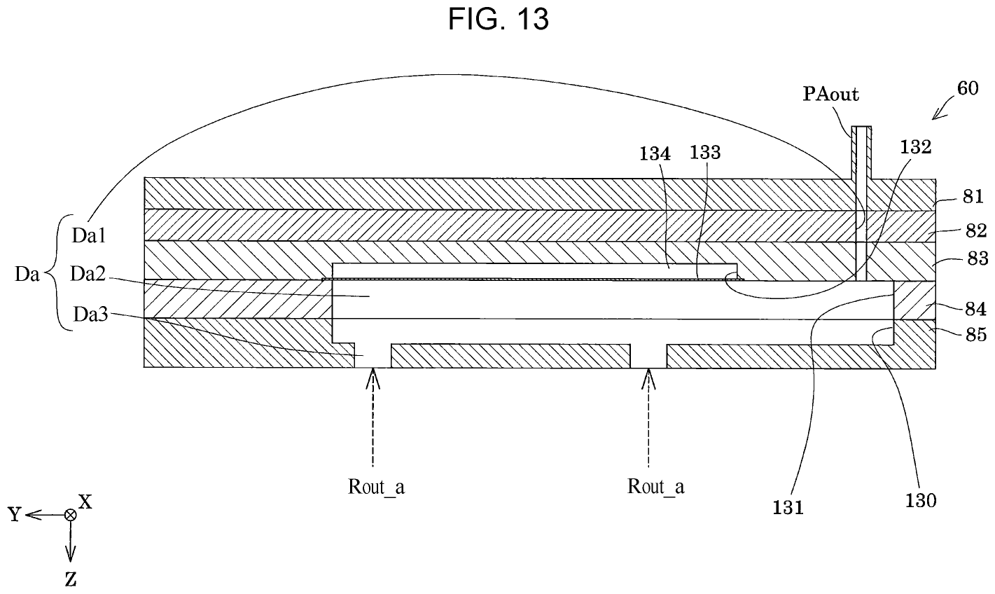

FIG. 8 is a cross-sectional view of the flow path member 60 according to the first embodiment. FIG. 9 is a plan view of a flow path substrate 83 when viewed in the +Z direction. FIG. 10 is a plan view of a flow path substrate 84 when viewed in the +Z direction. FIG. 11 is a plan view of a flow path substrate 85 when viewed in the +Z direction. FIG. 12 is a cross-sectional view taken along line XII-XII in FIGS. 8 to 11. FIG. 13 is a cross-sectional view taken along line XIII-XIII in FIGS. 8 to 11. In FIG. 9, a region in which flexible members 133 and 143 are disposed is illustrated by a one-dot chain line, and in FIG. 11, flexible members 113 and 123 are illustrated by hatching in which the outer periphery is surrounded by a one-dot chain line.

The flow path member 60 is a member in which a flow path for supplying the ink to the head chip 44 is formed. As described above, since the head chip 44 in the present embodiment is provided with two common liquid chambers SR, and each of the common liquid chambers SR is provided with the introduction port Rin and the discharge port Rout, two types of ink are circulated by being supplied to and discharged from the head chip 44. Thus, the flow path member 60 is provided with the first supply path Sa and the second supply path Sb through which two types of ink are supplied, and the first discharge path Da and the second discharge path Db through which two types of ink are discharged.

The supply path coupling portion PAin, the supply path coupling portion PBin, the discharge path coupling portion PAout, and the discharge path coupling portion PBout, which are cylindrical and protrude in the −Z direction are provided on the surface of the flow path member 60 facing the −Z direction. A first introduction portion Sa1 that is a portion of the first supply path Sa is provided inside the supply path coupling portion PAin, and a second introduction portion Sb1 that is a portion of the second supply path Sb is provided inside the supply path coupling portion PBin. A first flow-out portion Da1 that is a portion of the first discharge path Da is provided inside the discharge path coupling portion PAout, and a second flow-out portion Db1 that is a portion of the second discharge path Db is provided inside the discharge path coupling portion PBout.

A tube can be coupled to or removed from each of the supply path coupling portions PAin and PBin and the discharge path coupling portions PAout and PBout. The supply tube TAin is coupled to the supply path coupling portion PAin, and the supply tube TBin is coupled to the supply path coupling portion PBin. The discharge tube TAout is coupled to the discharge path coupling portion PAout, and the discharge tube TBout is coupled to the discharge path coupling portion PBout.

As illustrated in FIG. 7, the ink in the first liquid container 3A is pressurized to predetermined pressure by the pump 7 and is supplied to the first supply path Sa via the supply tube TAin and the supply path coupling portion PAin. The ink is branched in the first supply path Sa, passes through the communication path 34 of the holder 30, and is supplied to each of the introduction ports Rin_a of the two head chips 44. The ink discharged from each of the discharge ports Rout_a of the two head chips 44 passes through the communication path 34 of the holder 30, and merges in the first discharge path Da. Then, the ink is brought back to the first liquid container 3A via the discharge path coupling portion PAout and the discharge tube TAout. The first liquid container 3A, the supply tube TAin, the supply path coupling portion PAin, the discharge path coupling portion PAout, and the discharge tube TAout are configured to hold each of the nozzles N of the two head chips 44 at predetermined negative pressure.

The ink in the second liquid container 3B is pressurized to predetermined pressure by the pump 7 and is supplied to the second supply path Sb via the supply tube TBin and the supply path coupling portion PBin. The ink is branched in the second supply path Sb, passes through the communication path 34, and is supplied to each of the introduction ports Rin_b of the two head chips 44. The ink discharged from each of the discharge ports Rout_b of the two head chips 44 passes through the communication path 34, and merges in the second discharge path Db. Then, the ink is brought back to the second liquid container 3B via the discharge path coupling portion PBout and the discharge tube TBout. The second liquid container 3B, the supply tube TBin, the supply path coupling portion PBin, the discharge path coupling portion PBout, and the discharge tube TBout are also configured to hold the nozzles N of each of the two head chips 44 at predetermined negative pressure, as in the first liquid container 3A.

As described above, the holder 30 is provided with the communication path 34 through which the ink flows, and the holder 30 also functions as the flow path member. The flow path of the flow path member 60 may be directly coupled to the flow path of the head chip 44 without providing a flow path such as the communication path 34 in the holder 30. That is, a protrusion portion that protrudes in the +Z direction and is provided with a flow path therein may be provided on the surface of the flow path member 60 facing the +Z direction, and the protrusion portion may be inserted into the holder 30 and coupled to the head chip 44.

Specifically, the flow path member 60 includes a plurality of flow path substrates stacked in the Z-axis direction, and in the present embodiment, includes five flow path substrates. In the present embodiment, a flow path substrate 81, a flow path substrate 82, a flow path substrate 83, a flow path substrate 84, and a flow path substrate 85, which are the five flow path substrates, are stacked in this order in the +Z direction. In a plan view when viewed in the +Z direction, the outer shapes of the flow path substrates 81 to 85 are substantially the same.

The first supply path Sa and the second supply path Sb, the first discharge path Da and the second discharge path Db are provided inside such a flow path member 60. Different types of ink are supplied to the flow path member 60 in the first supply path Sa and the second supply path Sb, respectively.

The first supply path Sa includes a first introduction portion Sa1, a first supply common portion Sa2 that communicates with the first introduction portion Sa1 and extends in the Y-axis direction, and two first introduction port coupling portions Sa3 that communicate with the first supply common portion Sa2.

The first introduction portion Sa1 is a flow path provided in the flow path substrates 81 to 83 and is formed with a flow path extending in the Z-axis direction or the like. One end of the first introduction portion Sa1 is open at the tip of the supply path coupling portion PAin. A first liquid reservoir portion Sa1a and a second liquid reservoir portion Sa1b, which are widened and have a wider inner diameter than other regions, and a filter F disposed to separate the first liquid reservoir portion Sa1a and the second liquid reservoir portion Sa1b are provided at the stacked interface of the flow path substrates 82 and 83 of the first introduction portion Sa1. The filter F captures foreign substances such as dust and air bubbles contained in the ink.

The first supply common portion Sa2 is defined by a first supply common-portion recess portion 110 having a recessed shape that is open on the surface of the flow path substrate 83 facing the +Z direction, and a first supply common-portion penetration portion 111 provided to penetrate the flow path substrate 84 in the Z-axis direction. The first supply common-portion recess portion 110 and the first supply common-portion penetration portion 111 have substantially the same size when viewed in the Z-axis direction, and are disposed at overlapping positions. The first supply common portion Sa2 defined by the first supply common-portion recess portion 110 and the first supply common-portion penetration portion 111 extends in the Y-axis direction. Here, the phrase that the first supply common portion Sa2 extends in the Y-axis direction includes a case where the first supply common portion Sa2 has a shape that is long in the Y-axis direction and is short in the X-axis direction when viewed in the Z-axis direction. In addition, the phrase that the first supply common portion Sa2 extends in the Y-axis direction includes a case where the ink flows in the first supply common portion Sa2 along the Y-axis direction. In this regard, the same applies to a second supply common portion Sb2, a first discharge common portion Da2, and a second discharge common portion Db2, which will be described later. The other end of the first introduction portion Sa1 communicates with the bottom surface of the first supply common-portion recess portion 110.

The first introduction port coupling portion Sa3 is a flow path that couples the first supply common portion Sa2 and the introduction port Rin_a of each head chip 44, and in the present embodiment, two first introduction port coupling portions Sa3 are provided, which are the same number as the head chips 44. The first introduction port coupling portion Sa3 is provided to penetrate the flow path substrate 85 in the Z-axis direction. One end of the first introduction port coupling portion Sa3 communicates with the first supply common portion Sa2, and the other end communicates with the communication path 34.

Such a first supply path Sa takes in the ink from the first introduction portion Sa1, and the ink that has passed through the filter F is supplied to the first supply common portion Sa2. The ink supplied to the first supply common portion Sa2 is supplied to the introduction ports Rin_a of the two head chips 44 from the two first introduction port coupling portions Sa3 via the communication path 34.

That is, the first supply common portion Sa2 is a flow path that communicates in common with the common liquid chamber SRa1 of the head chip 44A and the common liquid chamber SRa2 of the head chip 44B.

The flow path substrate 85 is provided with a recess portion 112 that is open on the surface facing the −Z direction. The recess portion 112 is disposed at a position facing the first supply common portion Sa2 in the Z-axis direction. The flexible member 113 disposed to separate the first supply common portion Sa2 and the recess portion 112 is provided at the stacked interface of the flow path substrates 84 and 85. The flexible member 113 is a member that is formed of a material such as resin or metal having high durability with respect to the ink flowing through the first supply path Sa, and has a thin film shape and flexibility. A flexible member other than the flexible member 113 provided in the flow path member 60 described later only needs to be formed of the same material as the flexible member 113. A portion of the surface of the first supply common portion Sa2 facing the +Z direction is defined by the flexible member 113. An opening of the surface of the recess portion 112 facing the −Z direction is covered with the flexible member 113, thereby defining a compliance space 114. Here, the “compliance space” is a space in which a gas for displacing the flexible member is present, and is not a liquid chamber through which a liquid flows. It is preferable that the compliance space 114 be opened to the atmosphere through an atmosphere opening path (not illustrated). It is preferable that a compliance space (not illustrated) described later other than the compliance space 114 provided in the flow path member 60 be also opened to the atmosphere via the atmosphere opening path (not illustrated). As illustrated in FIGS. 11 and 12, the flow path substrate 85 includes a projection portion 115 that protrudes in the −Z direction from the bottom surface of the recess portion 112. The projection portion 115 is disposed inside the inner peripheral surface of the recess portion 112 when viewed in the +Z-axis direction, and a through hole penetrating in the Z-axis direction is formed to define a portion of the first introduction port coupling portion Sa3. The flexible member 113 is also stacked on the surface of the projection portion 115 facing the −Z direction, and the flexible member 113 is formed with a through hole at a position overlapping the first introduction port coupling portion Sa3 when viewed in the Z-axis direction so as not to block the first introduction port coupling portion Sa3.

As described above, the first supply common portion Sa2 is provided in the first supply path Sa, a portion of the first supply common portion Sa2 is defined by the flexible member 113, and the compliance space 114 is provided. In this manner, it is possible to absorb pressure fluctuation of the ink in the first supply common portion Sa2 by deformation of the flexible member 113 and to reduce the pressure fluctuation of the ink in the first supply path Sa.

The second supply path Sb has the same configuration as that of the first supply path Sa. Specifically, the second supply path Sb includes the second introduction portion Sb1, the second supply common portion Sb2 that communicates with the second introduction portion Sb1 and extends in the Y-axis direction, and two second introduction port coupling portions Sb3 that communicate with the second supply common portion Sb2.

The second introduction portion Sb1 is a flow path provided in the flow path substrates 81 to 83 and is formed with a flow path extending in the Z-axis direction or the like. One end of the second introduction portion Sb1 is open at the tip of the supply path coupling portion PBin. A third liquid reservoir portion Sb1a and a fourth liquid reservoir portion Sb1b, which are widened and have a wider inner diameter than other regions, and a filter F disposed to separate the third liquid reservoir portion Sb1a and the fourth liquid reservoir portion Sb1b are provided at the stacked interface of the flow path substrates 82 and 83 of the second introduction portion Sb1.

The second supply common portion Sb2 is defined by a second supply common-portion recess portion 120 having a recessed shape that is open on the surface of the flow path substrate 83 facing the +Z direction, and a second supply common-portion penetration portion 121 provided to penetrate the flow path substrate 84 in the Z-axis direction. The second supply common-portion recess portion 120 and the second supply common-portion penetration portion 121 have substantially the same size when viewed in the Z-axis direction, and are disposed at overlapping positions. Such a second supply common portion Sb2 extends in the Y-axis direction. The other end of the second introduction portion Sb1 communicates with the bottom surface of the second supply common-portion recess portion 120.

The second introduction port coupling portion Sb3 is a flow path that couples the second supply common portion Sb2 and the introduction port Rin_b of each head chip 44, and in the present embodiment, two second introduction port coupling portions Sb3 are provided, which are the same number as the head chips 44. The second introduction port coupling portion Sb3 is provided to penetrate the flow path substrate 85 in the Z-axis direction. One end of the second introduction port coupling portion Sb3 communicates with the second supply common portion Sb2, and the other end communicates with the communication path 34.

Such a second supply path Sb takes in the ink from the second introduction portion Sb1, and the ink that has passed through the filter F is supplied to the second supply common portion Sb2. The ink supplied to the second supply common portion Sb2 is supplied to the introduction ports Rin_b of the two head chips 44 from the two second introduction port coupling portions Sb3 via the communication path 34.

That is, the second supply common portion Sb2 is a flow path that communicates in common with the common liquid chamber SRb1 of the head chip 44A and the common liquid chamber SRb2 of the head chip 44B.

The flow path substrate 85 is provided with a recess portion 122 that is open on the surface facing the −Z direction. The recess portion 122 is disposed at a position facing the second supply common portion Sb2 in the Z-axis direction. The flexible member 123 disposed to separate the second supply common portion Sb2 and the recess portion 122 is provided at the stacked interface of the flow path substrates 84 and 85. A portion of the surface of the second supply common portion Sb2 facing the +Z direction is defined by the flexible member 123. An opening of the surface of the recess portion 122 facing the −Z direction is covered with the flexible member 123, thereby defining a compliance space 124. As illustrated in FIG. 11, the flow path substrate 85 includes a projection portion 125 that protrudes in the −Z direction from the bottom surface of the recess portion 122. The projection portion 125 is disposed inside the inner peripheral surface of the recess portion 122 when viewed in the +Z-axis direction, and a through hole penetrating in the Z-axis direction is formed to define a portion of the second introduction port coupling portion Sb3. The flexible member 123 is also stacked on the surface of the projection portion 125 facing the −Z direction, and the flexible member 123 is formed with a through hole at a position overlapping the second introduction port coupling portion Sb3 when viewed in the Z-axis direction so as not to block the second introduction port coupling portion Sb3.

In the present embodiment, since the flexible members 113 and 123 are provided at the same stacked interface, one common member is used. That is, one flexible member serves as the flexible members 113 and 123. As a result, it is possible to reduce the number of components and reduce the cost, and it is possible to simplify the assembly work. The flexible member 113 and the flexible member 123 may be configured as separate members.

As described above, the second supply common portion Sb2 is provided in the second supply path Sb, a portion of the second supply common portion Sb2 is defined by the flexible member 123, and the compliance space 124 is provided. In this manner, it is possible to absorb pressure fluctuation of the ink in the second supply common portion Sb2 by deformation of the flexible member 123 and to reduce the pressure fluctuation of the ink in the second supply path Sb.

The first discharge path Da includes the first flow-out portion Da1, the first discharge common portion Da2 communicating with the first flow-out portion Da1, and two first discharge port coupling portions Da3 communicating with the first discharge common portion Da2.

The first flow-out portion Da1 is a flow path provided in the flow path substrates 81 to 83 and is formed with a flow path extending in the Z-axis direction. One end of the first flow-out portion Da1 is open at the tip of the discharge path coupling portion PAout. The other end of the first flow-out portion Da1 is open on the surface of the flow path substrate 83 facing the +Z direction, and communicates with the first discharge common portion Da2. As illustrated in FIG. 7, a check valve 70 that regulates the flow of the ink from the outside to the inside of the liquid ejecting head H may be provided in the middle of the first flow-out portion Da1. The check valve 70 may be similarly provided in the middle of the second flow-out portion Db1 described later.

The first discharge common portion Da2 is defined by a first discharge common-portion recess portion 130 having a recessed shape that is open on the surface of the flow path substrate 85 facing the −Z direction, and a first discharge common-portion penetration portion 131 provided to penetrate the flow path substrate 84 in the Z-axis direction. The first discharge common-portion recess portion 130 and the first discharge common-portion penetration portion 131 have substantially the same size when viewed in the Z-axis direction, and are disposed at overlapping positions. The first discharge common portion Da2 defined by the first discharge common-portion recess portion 130 and the first discharge common-portion penetration portion 131 extends in the Y-axis direction.

The first discharge port coupling portion Da3 is a flow path that couples the first discharge common portion Da2 and the discharge port Rout_a of each head chip 44, and in the present embodiment, two first discharge port coupling portions Da3 are provided, which are the same number as the head chips 44. One end of the first discharge port coupling portion Da3 communicates with the bottom surface of the first discharge common-portion recess portion 130, and the other end is provided to be open on the surface of the flow path substrate 85 facing the +Z direction.

In such a first discharge path Da, the ink discharged from the discharge port Rout_a of the head chip 44 flows into the first discharge common portion Da2 via the communication path 34 and the first discharge port coupling portion Da3. The ink flowing into the first discharge common portion Da2 is discharged to the outside through the first flow-out portion Da1.

That is, the first discharge common portion Da2 is a flow path that communicates in common with the common liquid chamber SRa1 of the head chip 44A and the common liquid chamber SRa2 of the head chip 44B.

The flow path substrate 83 is provided with a recess portion 132 that is open on the surface facing the +Z direction. The recess portion 132 is disposed at a position facing the first discharge common portion Da2 in the Z-axis direction. The recess portion 132 is disposed at a position that does not overlap the first flow-out portion Da1 when viewed in the Z-axis direction. The flexible member 133 disposed to separate the first discharge common portion Da2 and the recess portion 132 is provided at the stacked interface of the flow path substrates 83 and 84. A portion of the surface of the first discharge common portion Da2 facing the −Z direction is defined by the flexible member 133. An opening of the surface of the recess portion 132 facing the +Z direction is covered with the flexible member 133, thereby defining a compliance space 134.

As described above, the first discharge common portion Da2 is provided in the first discharge path Da, a portion of the first discharge common portion Da2 is defined by the flexible member 133, and the compliance space 134 is provided. In this manner, it is possible to absorb pressure fluctuation of the ink in the first discharge common portion Da2 by deformation of the flexible member 133, and to reduce the pressure fluctuation of the ink in the first discharge path Da.

The second discharge path Db has the same configuration as the first discharge path Da. Specifically, the second discharge path Db includes the second flow-out portion Db1, the second discharge common portion Db2 communicating with the second flow-out portion Db1, and two second discharge port coupling portions Db3 communicating with the second discharge common portion Db2.

The second flow-out portion Db1 is a flow path provided in the flow path substrates 81 to 83 and is formed with a flow path extending in the Z-axis direction. One end of the second flow-out portion Db1 is open at the tip of the discharge path coupling portion PBout. The other end of the second flow-out portion Db1 is open on the surface of the flow path substrate 83 facing the +Z direction, and communicates with the second discharge common portion Db2.

The second discharge common portion Db2 is defined by a second discharge common-portion penetration portion 141 provided to penetrate the flow path substrate 84 in the Z-axis direction and a second discharge common-portion recess portion 140 having a recessed shape that is open on the surface of the flow path substrate 85 facing the −Z direction. The second discharge common-portion recess portion 140 and the second discharge common-portion penetration portion 141 have substantially the same size when viewed in the Z-axis direction, and are disposed at overlapping positions. The second discharge common portion Db2 defined by the second discharge common-portion recess portion 140 and the second discharge common-portion penetration portion 141 extends in the Y-axis direction.

The second discharge port coupling portion Db3 is a flow path that couples the second discharge common portion Db2 and the discharge port Rout_b of each head chip 44, and in the present embodiment, two second discharge port coupling portions Db3 are provided, which are the same number as the head chips 44. One end of the second discharge port coupling portion Db3 communicates with the bottom surface of the second discharge common-portion recess portion 140, and the other end is provided to be open on the surface of the flow path substrate 85 facing the +Z direction.

In such a second discharge path Db, the ink discharged from the discharge port Rout_b of the head chip 44 flows into the second discharge common portion Db2 via the communication path 34 and the second discharge port coupling portion Db3. The ink flowing into the second discharge common portion Db2 is discharged to the outside through the second flow-out portion Db1.

That is, the second discharge common portion Db2 is a flow path that communicates in common with the common liquid chamber SRb1 of the head chip 44A and the common liquid chamber SRb2 of the head chip 44B.

The flow path substrate 83 is provided with a recess portion 142 that is open on the surface facing the +Z direction. The recess portion 142 is disposed at a position facing the second discharge common portion Db2 in the Z-axis direction. The recess portion 142 is disposed at a position that does not overlap the second flow-out portion Db1 when viewed in the Z-axis direction. The flexible member 143 disposed to separate the second discharge common portion Db2 and the recess portion 142 is provided at the stacked interface of the flow path substrates 83 and 84. A portion of the surface of the second discharge common portion Db2 facing the −Z direction is defined by the flexible member 143. An opening of the surface of the recess portion 142 facing the +Z direction is covered with the flexible member 143, thereby defining a compliance space 144. In the present embodiment, since the flexible members 133 and 143 are provided at the same stacked interface, one common member is used. That is, one flexible member serves as the flexible members 133 and 143. As a result, it is possible to reduce the number of components and reduce the cost, and it is possible to simplify the assembly work. The flexible member 133 and the flexible member 143 may be configured as separate members.

As described above, the second discharge common portion Db2 is provided in the second discharge path Db, a portion of the second discharge common portion Db2 is defined by the flexible member 143, and the compliance space 144 is provided. In this manner, it is possible to absorb pressure fluctuation of the ink in the second discharge common portion Db2 by deformation of the flexible member 143, and to reduce the pressure fluctuation of the ink in the second discharge path Db.

The first supply common portion Sa2, the second supply common portion Sb2, the first discharge common portion Da2, and the second discharge common portion Db2 are disposed at positions that do not overlap each other when viewed in the Z-axis direction. That is, when viewed in the Z-axis direction, the compliance space 114 does not overlap the second supply common portion Sb2, the first discharge common portion Da2, and the second discharge common portion Db2, and the compliance space 124 does not overlap the first supply common portion Sa2, the first discharge common portion Da2, and the second discharge common portion Db2. Similarly, when viewed in the Z-axis direction, the compliance space 134 does not overlap the first supply common portion Sa2, the second supply common portion Sb2, and the first discharge common portion Da2, and the compliance space 144 does not overlap the first supply common portion Sa2, the second supply common portion Sb2, and the second discharge common portion Db2. In the present embodiment, the compliance space 114 and the compliance space 124 are defined by the recess portion 112 and the recess portion 122 of the flow path substrate 85 in which the recess portion 132 and the recess portion 142 that define a portion of the first discharge common portion Da2 and a portion of the second discharge common portion Db2 are formed. That is, a recess portion defining a compliance space is formed at the substrate defining a common portion of the flow path. Therefore, it is not necessary to provide a member that defines the compliance space separately from the member that forms the flow path. Thus, by forming the recess portion defining the compliance space at the substrate defining the common portion of the flow path, it is possible to reduce the number of components of the flow path member 60 and to reduce the cost, and it is possible to simplify the assembly of the flow path member 60. Similarly, since the compliance space 134 and the compliance space 144 are defined by the recess portion 132 and the recess portion 142 formed at the flow path substrate 83 in which the first flow-out portion Da1 and the second flow-out portion Db1 are formed, it is not necessary to provide a member that defines the compliance space separately from a member that forms the flow path.

Here, when the liquid ejecting apparatus 1 performs printing, for example, the liquid ejecting apparatus 1 discharges the ink from the two head chips 44 while moving the liquid ejecting head H in the +Y direction. At this time, since the head chip 44A disposed in the +Y direction with respect to the medium S faces the medium S before the head chip 44B disposed in the −Y direction, printing is performed in a manner that the ink is discharged from the head chip 44A disposed in the +Y direction in the liquid ejecting head H first, and then the ink is discharged from the head chip 44B disposed in the −Y direction. At this time, when the discharge of the ink is started from the head chip 44A, the ink is not discharged from the head chip 44B. Therefore, the negative pressure in the common liquid chamber SRa1 may act on the inside of the common liquid chamber SRa2 via the flow path common to the head chip 44A and the head chip 44B, for example, the first supply common portion Sa2 that communicates with both the common liquid chamber SRa1 communicating with the nozzle row La1 and the common liquid chamber SRa2 communicating with the nozzle row La2. Thus, there is a concern that the ink is not normally discharged from the nozzle row La2. However, in the present embodiment, portions of the first supply common portion Sa2 of the first supply path Sa, the second supply common portion Sb2 of the second supply path Sb, the first discharge common portion Da2 of the first discharge path Da, and the second discharge common portion Db2 of the second discharge path Db, which are the flow paths communicating with the two head chips 44 in common, are defined by the flexible member 113, the flexible member 123, the flexible member 133, and the flexible member 143. Therefore, it is possible to absorb the negative pressure generated in the flow paths by deforming the flexible members 113 to 143. Thus, even when a plurality of head chips 44 in which the discharge of the ink is started at different timings are provided as described above, it is possible to suppress the action of the negative pressure of one head chip 44 on the negative pressure of the other head chip 44. It is possible to reduce the variation in the weight of the ink discharged from each head chip 44, and thus it is possible to suppress an occurrence of uneven density in a printed matter.

In the present embodiment, since the flexible members 113 and 123 are provided as one member common to the plurality of first supply common portions Sa2 and second supply common portions Sb2, it is possible to reduce the number of components and reduce the cost, and it is possible to simplify the assembly of the flow path member 60. Similarly, since the flexible members 133 and 143 are provided as one member common to the plurality of first discharge common portions Da2 and the second discharge common portions Db2, it is possible to reduce the number of components and reduce the cost, and it is possible to simplify the assembly of the flow path member 60.

In addition, since the compliance spaces 114 to 144 are individually defined for the first supply common portion Sa2, the second supply common portion Sb2, the first discharge common portion Da2, and the second discharge common portion Db2, respectively, the flexible members 113 to 143 are pressed by partition walls that separate the compliance spaces 114 to 144. Therefore, the flexible members 113 to 143 are less likely to peel off from the flow path member 60, and it is possible to suppress the leakage of the ink to the outside.

As illustrated in FIGS. 2 and 4, the flow path member 60 is accommodated in the cover member 65 fixed to the holder 30 on the −Z direction side.

The cover member 65 is provided with the four through holes 67 on the surface on the −Z direction side, and the supply path coupling portion PAin, the supply path coupling portion PBin, the discharge path coupling portion PAout, and the discharge path coupling portion PBout are exposed to the outside from these four through holes 67.

As illustrated in FIG. 4, a relay substrate 73 having a connector 75 is accommodated inside the cover member 65. The connector 75 provided at the relay substrate 73 is exposed to the outside from a coupling opening portion 63, which is a through hole provided on the surface of the cover member 65 on the −Z direction side, and a wiring (not illustrated) for being coupled to the controller 4 on the outside is coupled to the connector 75. The plurality of head chips 44 and the relay substrate 73 are electrically coupled to each other by wirings (not illustrated).

In the present embodiment, the Z-axis direction is an example of a “first direction”, and the Y-axis direction is an example of a “second direction”. The flow path member 60 is an example of a “flow path structure body”. In the present embodiment, any one of the two head chips 44 is an example of a “first head chip”. In this case, the nozzle row L of the first head chip and the common liquid chamber SR communicating with the nozzle row L are examples of a “first nozzle group” and a “first common liquid chamber portion”. In addition, any one of the head chips 44 other than the first head chip of the two head chips 44 is an example of a “second head chip”, and the nozzle row L of the second head chip and the common liquid chamber SR communicating with the nozzle row L are examples of a “second nozzle group” and a “second common liquid chamber portion”.

Any of the first supply path Sa, the second supply path Sb, the first discharge path Da, and the second discharge path Db is an example of a “first flow path”, and any of the first supply common portion Sa2, the second supply common portion Sb2, the first discharge common portion Da2, and the second discharge common portion Db2 is an example of a “first common portion”. In addition, any of the first supply path Sa, the second supply path Sb, the first discharge path Da, and the second discharge path Db is an example of a “second flow path”, and any of the first supply common portion Sa2, the second supply common portion Sb2, the first discharge common portion Da2, and the second discharge common portion Db2 is an example of a “second common portion”.

Any one of the flexible member 113 and the flexible member 123, and the flexible member 133 and the flexible member 143 is an example of a “first flexible member”, and the other is an example of a “second flexible member”.

Any one or both of the compliance spaces 114 and 124 are examples of a “first compliance space”, and any one or both of the compliance spaces 134 and 144 are examples of a “second compliance space”.

Any one of the flow path substrates 83 and 85 in the present embodiment is an example of a “first flow path substrate”, the other is an example of a “second flow path substrate”, and the flow path substrate 84 is an example of a “third flow path substrate”.

Specifically, when the head chip 44A is an example of the “first head chip”, the head chip 44B is an example of the “second head chip”, the nozzle row La1 of the head chip 44A and the common liquid chamber SRa1 communicating with the nozzle row La1 are examples of the “first nozzle group” and the “first common liquid chamber portion”, the nozzle row La2 of the head chip 44B and the common liquid chamber SRa2 communicating with the nozzle row La2 are examples of the “second nozzle group” and the “second common liquid chamber portion”, the first supply path Sa is an example of a “first flow path”, the first supply common portion Sa2 is an example of a “first common portion”, the first discharge path Da is an example of a “second flow path”, the first discharge common portion Da2 is an example of a “second common portion”, the flexible member 113 is an example of a “first flexible member”, and the flexible member 133 is an example of a “second flexible member”. Furthermore, the compliance space 114 is an example of a “first compliance space”, and the compliance space 134 is an example of a “second compliance space”. The flow path substrate 85 in the present embodiment is an example of the “first flow path substrate”, the flow path substrate 83 is an example of the “second flow path substrate”, and the flow path substrate 84 is an example of the “third flow path substrate”.

### Second Embodiment

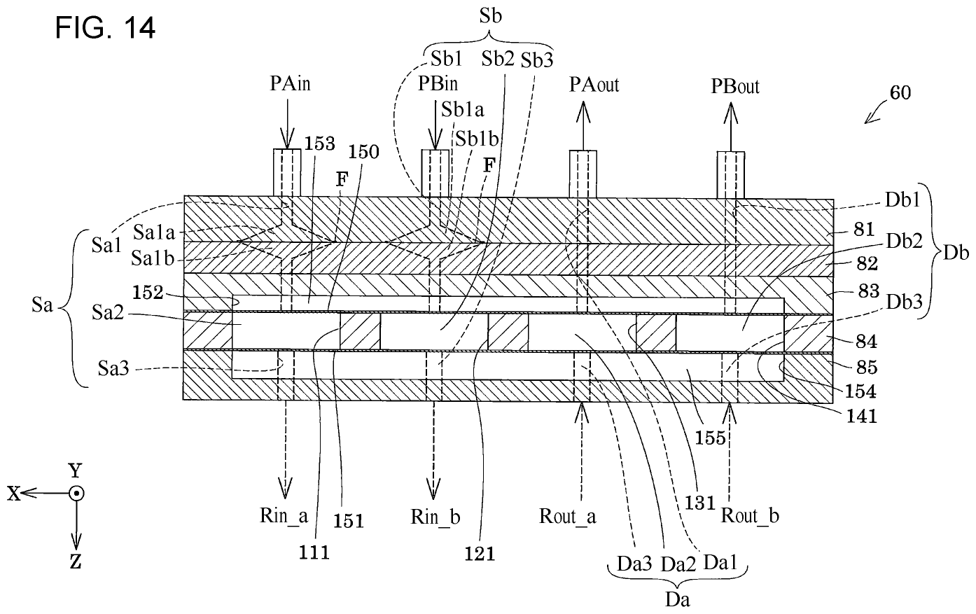

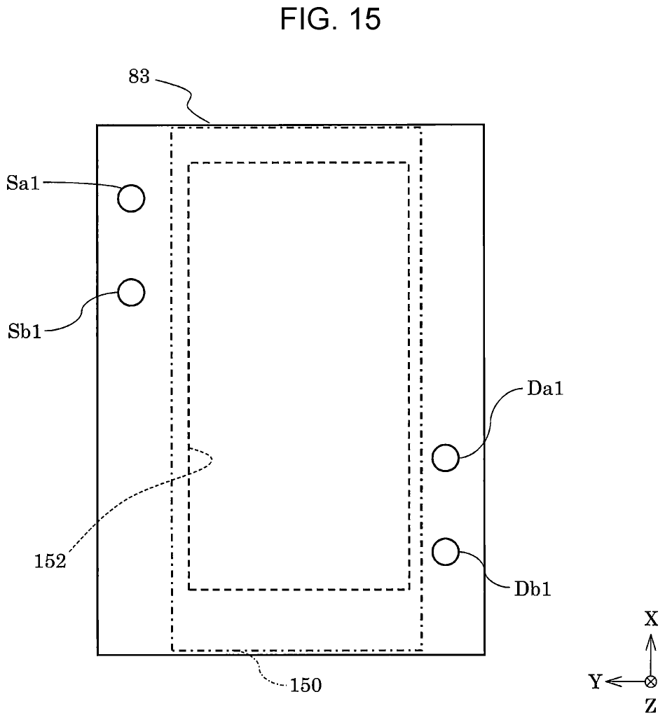

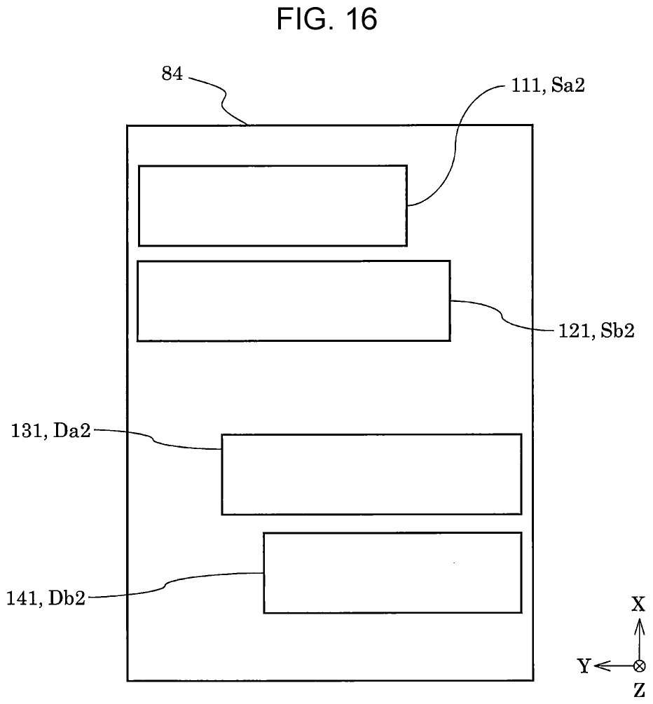

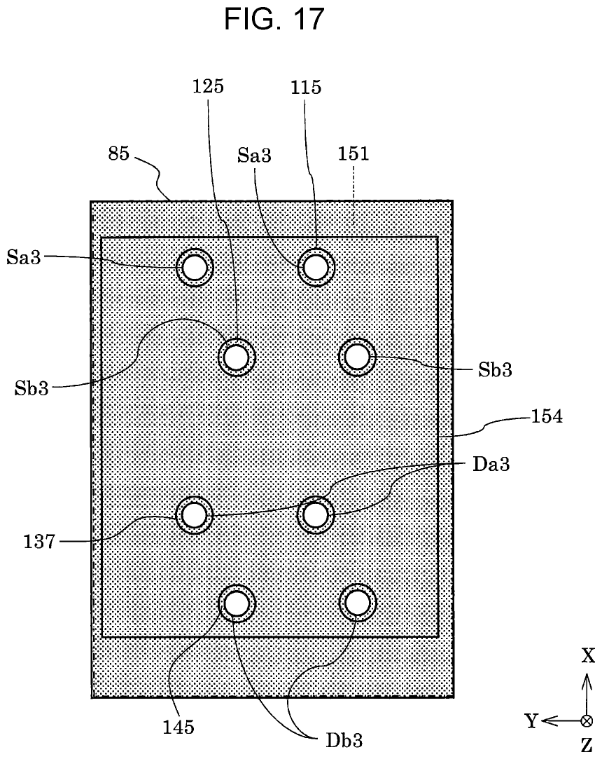

FIG. 14 is a cross-sectional view of a main portion of a flow path member 60 according to a second embodiment of the present disclosure. FIG. 15 is a plan view of a flow path substrate 83 when viewed in the +Z direction. FIG. 16 is a plan view of a flow path substrate 84 when viewed in the +Z direction. FIG. 17 is a plan view of a flow path substrate 85 when viewed in the +Z direction. In FIG. 15, a region in which a flexible member 150 is disposed is illustrated by a one-dot chain line, and in FIG. 17, a flexible member 151 is illustrated by hatching in which the outer periphery is surrounded by a one-dot chain line. The same reference signs will be given to the same members as those in the above-described embodiment, and the repetitive description thereof will be omitted. Although not illustrated, a head chip 44 has the same configuration as that of the above-described first embodiment.

As in the first embodiment described above, the flow path member 60 includes flow path substrates 81 to 85. In a plan view when viewed in the +Z direction, the outer shapes of the flow path substrates 81 to 85 are substantially the same. The flow path member 60 includes a first supply path Sa and a second supply path Sb, and a first discharge path Da and a second discharge path Db.

A side surface of a first supply common portion Sa2 is defined by a first supply common-portion penetration portion 111 provided to penetrate the flow path substrate 84 in the Z-axis direction.

A side surface of a second supply common portion Sb2 is defined by a second supply common-portion penetration portion 121 provided to penetrate the flow path substrate 84 in the Z-axis direction.

As illustrated in FIG. 17, projection portions 115 and 125 in the present embodiment are disposed inside the inner peripheral surface of a recess portion 154 when viewed in the +Z-axis direction.

A side surface of a first discharge common portion Da2 is defined by a first discharge common-portion penetration portion 131 provided to penetrate the flow path substrate 84 in the Z-axis direction.

As illustrated in FIG. 17, the flow path substrate 85 has a projection portion 137 that protrudes in the −Z direction from the bottom surface of the recess portion 154. The projection portion 137 is disposed inside the inner peripheral surface of the recess portion 154 when viewed in the +Z-axis direction, and a through hole penetrating in the Z-axis direction is formed to define a portion of a first discharge port coupling portion Da3. A flexible member 151 is also stacked on the surface of the projection portion 137 facing the −Z direction. The flexible member 151 is formed with a through hole at a position overlapping the first discharge port coupling portion Da3 when viewed in the Z-axis direction so as not to block the first discharge port coupling portion Da3.

A side surface of a second discharge common portion Db2 is defined by a second discharge common-portion penetration portion 141 provided to penetrate the flow path substrate 84 in the Z-axis direction.

Portions of the surfaces of the first supply common portion Sa2, the second supply common portion Sb2, the first discharge common portion Da2, and the second discharge common portion Db2 in the −Z direction are defined by the flexible member 150. In addition, portions of the surfaces of the first supply common portion Sa2, the second supply common portion Sb2, the first discharge common portion Da2, and the second discharge common portion Db2 in the +Z direction are defined by the flexible member 151. That is, each of the flexible members 150 and 151 is a common member that defines portions of the first supply common portion Sa2, the second supply common portion Sb2, the first discharge common portion Da2, and the second discharge common portion Db2.

As illustrated in FIG. 17, the flow path substrate 85 has a projection portion 145 that protrudes in the −Z direction from the bottom surface of the recess portion 154. The projection portion 145 is disposed inside the inner peripheral surface of the recess portion 154 when viewed in the +Z-axis direction, and a through hole penetrating in the Z-axis direction is formed to define a portion of a second discharge port coupling portion Db3. The flexible member 151 is also stacked on the surface of the projection portion 145 facing the −Z direction. The flexible member 151 is formed with a through hole at a position overlapping the second discharge port coupling portion Db3 when viewed in the Z-axis direction so as not to block the second discharge port coupling portion Db3.

The flow path substrate 83 is formed with a recess portion 152 that is open in the +Z direction. The recess portion 152 is disposed at a position that overlaps the first supply common portion Sa2, the second supply common portion Sb2, the first discharge common portion Da2, and the second discharge common portion Db2 when viewed in the +Z direction. An opening of the recess portion 152 in the +Z direction is covered with the flexible member 150 to define a compliance space 153. A portion of the flexible member 150 that defines the first supply common portion Sa2, the second supply common portion Sb2, the first discharge common portion Da2, and the second discharge common portion Db2 by the compliance space 153 is deformable. Specifically, a portion of the flexible member 150 that closes the recess portion 152 is deformable in a portion that overlaps each of the first supply common-portion penetration portion 111, the second supply common-portion penetration portion 121, the first discharge common-portion penetration portion 131, and the second discharge common-portion penetration portion 141 when viewed in the Z-axis direction.

The flow path substrate 85 is formed with a recess portion 154 that is open in the −Z direction. The recess portion 154 is disposed at a position that overlaps the first supply common portion Sa2, the second supply common portion Sb2, the first discharge common portion Da2, and the second discharge common portion Db2 when viewed in the +Z direction. An opening of the recess portion 154 in the +Z direction is covered with the flexible member 151 to define a compliance space 155. A portion of the flexible member that defines the first supply common portion Sa2, the second supply common portion Sb2, the first discharge common portion Da2, and the second discharge common portion Db2 by the compliance space 155 is deformable. Specifically, a portion of the flexible member 151 that closes the recess portion 154 is deformable in a portion that overlaps each of the first supply common-portion penetration portion 111, the second supply common-portion penetration portion 121, the first discharge common-portion penetration portion 131, and the second discharge common-portion penetration portion 141 when viewed in the Z-axis direction.

A first introduction portion Sa1 communicates with a portion of the first supply common-portion penetration portion 111 that does not overlap the recess portion 152 when viewed in the Z-axis direction. A second introduction portion Sb1 communicates with the second supply common portion Sb2 in a portion of the second supply common-portion penetration portion 121 that does not overlap the recess portion 152 when viewed in the Z-axis direction. A second flow-out portion Db1 communicates with a portion of the second discharge common-portion penetration portion 141 that does not overlap the recess portion 152 when viewed in the Z-axis direction. A first flow-out portion Da1 communicates with a portion of the first discharge common-portion penetration portion 131 that does not overlap the recess portion 152 when viewed in the Z-axis direction. That is, the first introduction portion Sa1, the second introduction portion Sb1, the second flow-out portion Db1, and the first flow-out portion Da1 are open on the surface of the flow path substrate 83 that is stacked on the flow path substrate 84.

In a liquid ejecting head H having such a flow path member 60 in the present embodiment, the same effect as that of the first embodiment can be exhibited.

In the present embodiment, since the surfaces of portions of the first supply common portion Sa2, the second supply common portion Sb2, the first discharge common portion Da2, and the second discharge common portion Db2 in the −Z direction and the +Z direction are respectively defined by the flexible members 150 and 151, it is possible to increase the compliance capacity of each of the first supply common portion Sa2, the second supply common portion Sb2, the first discharge common portion Da2, and the second discharge common portion Db2 without increasing the size of the flow path member 60 in a direction perpendicular to the Z-axis direction. In addition, by providing the compliance spaces 153 and 155 in common to the first supply common portion Sa2, the second supply common portion Sb2, the first discharge common portion Da2, and the second discharge common portion Db2, it is possible to increase the amount of pressure fluctuation that can be absorbed.

Further, in the present embodiment, by using the flexible members 150 and 151 that commonly define the first supply common portion Sa2, the second supply common portion Sb2, the first discharge common portion Da2, and the second discharge common portion Db2, it is possible to reduce the number of components and reduce the cost, and it is possible to simplify the assembly. Each of the first supply common portion Sa2, the second supply common portion Sb2, the first discharge common portion Da2, and the second discharge common portion Db2 may be provided with an independent flexible member, and each set configured by two or more first supply common portions Sa2, two or more second supply common portions Sb2, two or more first discharge common portions Da2, and two or more second discharge common portions Db2 may be provided with an independent flexible member.

In the present embodiment, the Z-axis direction is an example of a “first direction”, and the Y-axis direction is an example of a “second direction”. The flow path member 60 is an example of a “flow path structure body”. In the present embodiment, any one of the two head chips 44 is an example of a “first head chip”, and the nozzle row L of the first head chip and the common liquid chamber SR communicating with the nozzle row L are examples of a “first nozzle group” and a “first common liquid chamber portion”. In addition, any one of the head chips 44 other than the first head chip of the two head chips 44 is an example of a “second head chip”, and the nozzle row L of the second head chip and the common liquid chamber SR communicating with the nozzle row L are examples of a “second nozzle group” and a “second common liquid chamber portion”.

Any of the first supply path Sa, the second supply path Sb, the first discharge path Da, and the second discharge path Db is an example of a “first flow path”, and any of the first supply common portion Sa2, the second supply common portion Sb2, the first discharge common portion Da2, and the second discharge common portion Db2 is an example of a “first common portion”. In addition, any of the first supply path Sa, the second supply path Sb, the first discharge path Da, and the second discharge path Db is an example of a “second flow path”, and any of the first supply common portion Sa2, the second supply common portion Sb2, the first discharge common portion Da2, and the second discharge common portion Db2 is an example of a “second common portion”.

In addition, any one of the flexible members 150 and 151 is an example of a “first flexible member”, and the other is an example of a “second flexible member”.

In addition, any one of the flexible member 150, the compliance space 153, and the flow path substrate 83, and the flexible member 151, the compliance space 155, and the flow path substrate 85 are examples of a “first flexible member”, a “first compliance space”, and a “first flow path substrate”, and the others are examples of a “second flexible member”, a “second compliance space”, and a “third flow path substrate”.

In addition, the flow path substrate 84 is an example of a “third flow path substrate”.

Specifically, when the head chip 44A is an example of the “first head chip”, the head chip 44B is an example of the “second head chip”, the nozzle row La1 of the head chip 44A and the common liquid chamber SRa1 communicating with the nozzle row La1 are examples of the “first nozzle group” and the “first common liquid chamber portion”, the nozzle row La2 of the head chip 44B and the common liquid chamber SRa2 communicating with the nozzle row La2 are examples of the “second nozzle group” and the “second common liquid chamber portion”, the first supply path Sa is an example of a “first flow path”, the first supply common portion Sa2 is an example of a “first common portion”, the first discharge path Da is an example of a “second flow path”, the first discharge common portion Da2 is an example of a “second common portion”, the flexible member 151 is an example of a “first flexible member”, and the flexible member 150 is an example of a “second flexible member”. Furthermore, the compliance space 155 is an example of a “first compliance space”, and the compliance space 153 is an example of a “second compliance space”. The flow path substrate 85 in the present embodiment is an example of the “first flow path substrate”, the flow path substrate 83 is an example of the “second flow path substrate”, and the flow path substrate 84 is an example of the “third flow path substrate”.

### Third Embodiment

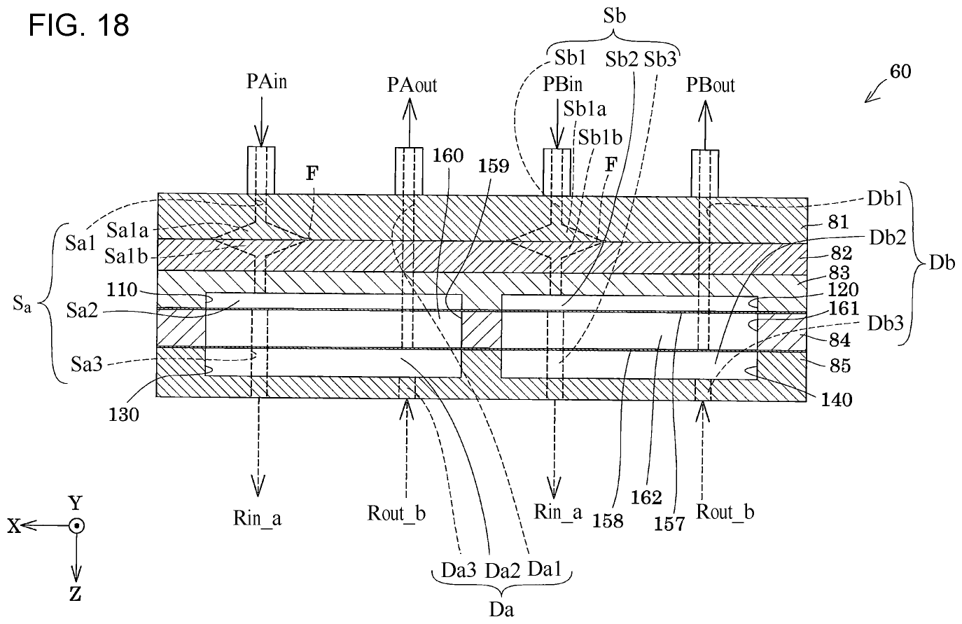

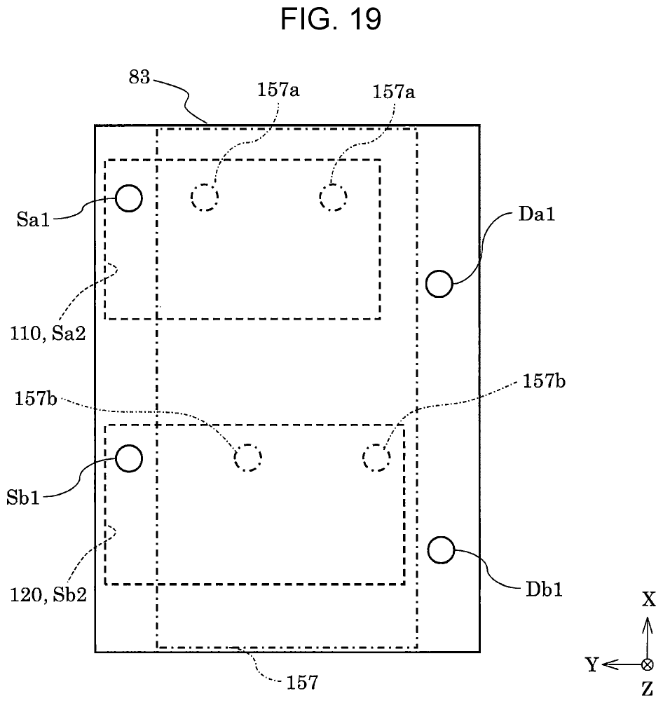

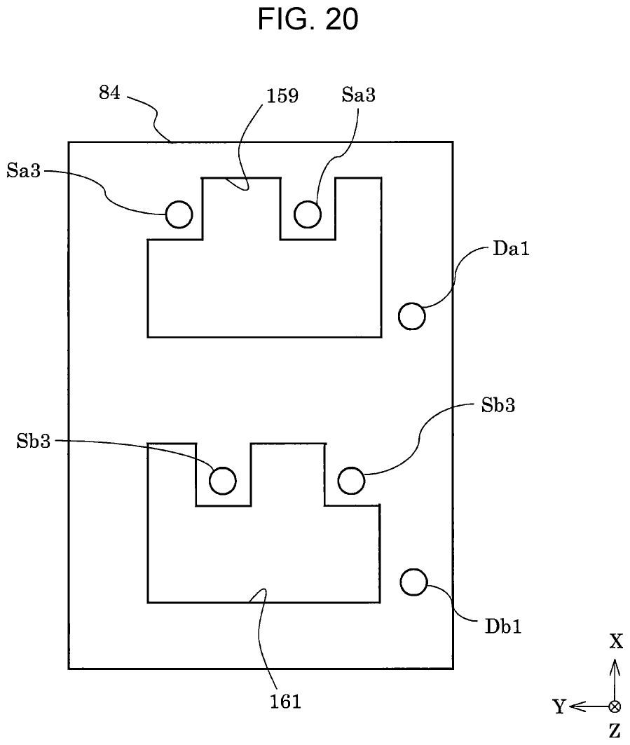

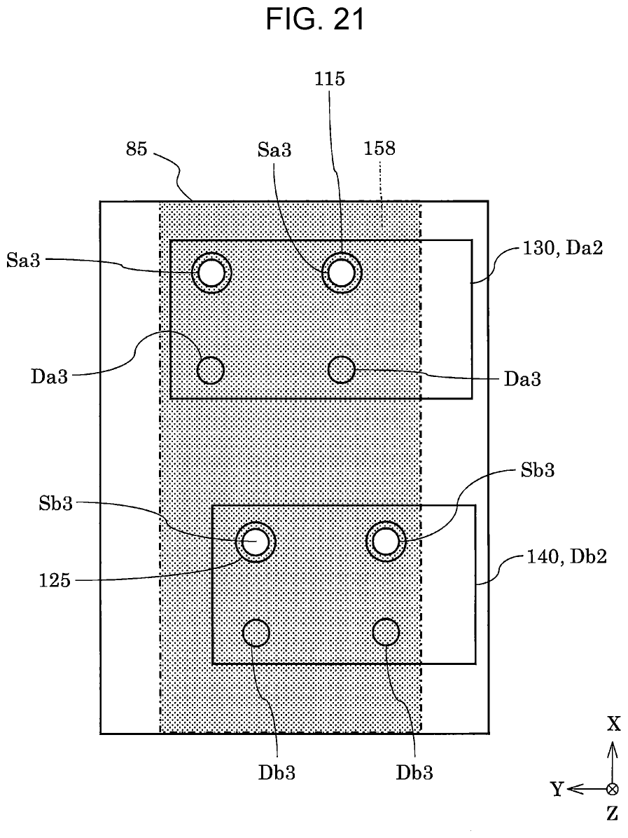

FIG. 18 is a cross-sectional view of a main portion of a flow path member according to a third embodiment of the present disclosure. FIG. 19 is a plan view of a flow path substrate 83 when viewed in the +Z direction. FIG. 20 is a plan view of a flow path substrate 84 when viewed in the +Z direction. FIG. 21 is a plan view of a flow path substrate 85 when viewed in the +Z direction. In FIG. 19, a region in which a flexible member 157 is disposed is illustrated by a one-dot chain line, and in FIG. 21, a flexible member 158 is illustrated by hatching in which the outer periphery is surrounded by a one-dot chain line. The same reference signs will be given to the same members as those in the above-described embodiment, and the repetitive description thereof will be omitted. Although not illustrated, a head chip 44 has the same configuration as that of the above-described first embodiment.

As in the first embodiment described above, the flow path member 60 includes flow path substrates 81 to 85. In a plan view when viewed in the +Z direction, the outer shapes of the flow path substrates 81 to 85 are substantially the same. The flow path member 60 includes a first supply path Sa and a second supply path Sb, and a first discharge path Da and a second discharge path Db.

A portion of the surface of each of a first supply common portion Sa2 and a second supply common portion Sb2 in the +Z direction is defined by the flexible member 157. That is, the flexible member 157 is a common member that defines portions of the first supply common portion Sa2 and the second supply common portion Sb2. The flexible member 157 is held between the flow path substrates 83 and 84.

A first introduction port coupling portion Sa3 and a second introduction port coupling portion Sb3 is provided to penetrate the flow path substrates 84 and 85 in the Z-axis direction, respectively. The first introduction port coupling portion Sa3 communicates with the first supply common portion Sa2 via a through hole 157a formed at a position overlapping the first introduction port coupling portion Sa3 of the flexible member 157. The second introduction port coupling portion Sb3 communicates with the second supply common portion Sb2 via a through hole 157b formed at a position overlapping the second introduction port coupling portion Sb3 of the flexible member 157. A portion of the first introduction port coupling portion Sa3 is formed by penetrating the inside of a projection portion 115 that protrudes in the −Z direction from the bottom surface of a first discharge common-portion recess portion 130 described later in the Z-axis direction. A portion of the second introduction port coupling portion Sb3 is formed by penetrating the inside of a projection portion 125 that protrudes in the −Z direction from the bottom surface of a second discharge common-portion recess portion 140 described later in the Z-axis direction. The projection portions 115 and 125 have the same configuration as in the first embodiment.

Each of a first flow-out portion Da1 and a second flow-out portion Db1 is a flow path that is formed by penetrating the flow path substrates 81 to 84 and extends in the Z-axis direction. That is, the first flow-out portion Da1 is open to the surface of the flow path substrate 84 facing the +Z direction, and communicates with a first discharge common portion Da2. The second flow-out portion Db1 is open on the surface of the flow path substrate 84 facing the +Z direction, and communicates with a second discharge common portion Db2.

The first discharge common portion Da2 is defined by a first discharge common-portion recess portion 130 having a recessed shape that is open on the surface of the flow path substrate 85 facing the −Z direction. The second discharge common portion Db2 is defined by a second discharge common-portion recess portion 140 having a recessed shape that is open on the surface of the flow path substrate 85 facing the −Z direction. Each of the first discharge common portion Da2 and the second discharge common portion Db2 extends in the Y-axis direction.

The first discharge common portion Da2 is disposed at a position that overlaps at least a portion of the first supply common portion Sa2 when viewed in the Z-axis direction. Therefore, it is possible to reduce the size of the flow path member 60 along an XY plane as compared with the case where the first supply common portion Sa2 and the first discharge common portion Da2 are arranged side by side on the XY plane defined by the X-axis direction and the Y-axis direction.

The second discharge common portion Db2 is disposed at a position that overlaps at least a portion of the second supply common portion Sb2 when viewed in the Z-axis direction. Therefore, it is possible to reduce the size of the flow path member 60 along the XY plane as compared with the case where the second supply common portion Sb2 and the second discharge common portion Db2 are arranged side by side on the XY plane defined by the X-axis direction and the Y-axis direction.

In addition, a portion of the surface of each of the first discharge common portion Da2 and the second discharge common portion Db2 in the −Z direction is defined by the flexible member 158. That is, the flexible member 158 is a common member that defines portions of the first supply common portion Sa2, the first discharge common portion Da2, and the second discharge common portion Db2. The flexible member 158 is held between the flow path substrates 84 and 85.

Each of the first discharge port coupling portion Da3 and the second discharge port coupling portion Db3 is formed by penetrating the flow path substrate 85 in the Z-axis direction.

The flow path substrate 84 is provided with a first penetration portion 159 penetrating in the Z-axis direction, at a position that overlaps the first supply common portion Sa2 and the first discharge common portion Da2 when viewed in the Z-axis direction, and is provided with a second penetration portion 161 penetrating in the Z-axis direction, at a position that overlaps the second supply common portion Sb2 and the second discharge common portion Db2 when viewed in the Z-axis direction.

An opening of each of the first penetration portion 159 and the second penetration portion 161 in the −Z direction is covered with the flexible member 157, and an opening of each of the first penetration portion 159 and the second penetration portion 161 in the +Z direction is covered with the flexible member 158. As a result, a compliance space 160 is defined inside the first penetration portion 159, and a compliance space 162 is defined inside the second penetration portion 161. By providing the compliance space 160 as described above, a portion of the flexible member 157 that defines the first supply common portion Sa2 and a portion of the flexible member 158 that defines the first discharge common portion Da2 are deformable. That is, the flexible members 157 and 158 define the compliance space 160 common to the first supply common portion Sa2 and the first discharge common portion Da2. Further, by providing the compliance space 162 as described above, a portion of the flexible member 157 that defines the second supply common portion Sb2 and a portion of the flexible member 158 that defines the second discharge common portion Db2 are deformable. That is, the flexible members 157 and 158 define the compliance space 162 common to the second supply common portion Sb2 and the second discharge common portion Db2.

In a liquid ejecting head H having such a flow path member 60 in the present embodiment, the same effect as that of the above-described embodiments can also be exhibited.

Further, since the compliance space for deforming the flexible members 157 and 158 is shared in one space, it is possible to reduce the size of the flow path member 60 in the Z-axis direction as compared with the case where the independent compliance spaces are provided.

In addition, by disposing the first supply common portion Sa2 and the first discharge common portion Da2 at positions overlapping each other in the Z-axis direction and disposing the second supply common portion Sb2 and the second discharge common portion Db2 at positions overlapping each other in the Z-axis direction, it is possible to reduce the size of the flow path member 60 on the XY plane as compared with the case where any two of the supply common portions and the discharge common portions are arranged on the XY plane.

In the present embodiment, by individually providing the compliance spaces 160 and 162, the flexible members 157 and 158 can be pressed between the flexible members 157 and 158 and the flow path substrate 83, and between the flexible members 157 and the flow path substrate 85 by a partition wall between the compliance spaces 160 and 162. Thus, it is possible to suppress peeling due to the deformation of each of the flexible members 157 and 158 and to suppress the leakage of the ink.

In the present embodiment, the compliance spaces 160 and 162 are individually provided, but the present embodiment is not limited thereto, and the compliance spaces 160 and 162 may be continuous. As a result, it is possible to suppress an occurrence of a situation in which the flexible members 157 and 158 facing the compliance spaces 160 and 162 are pressed by the partition wall that separates the flexible members 157 and 158, and to increase the compliance capacity.

In the present embodiment, as can be seen from FIG. 21, the positions where the introduction port Rin and the discharge port Rout are disposed with respect to the common liquid chamber SR are different. For example, a pair of the first introduction port coupling portion Sa3 and the first discharge port coupling portion Da3 arranged in the X-axis direction communicate with each of the introduction port Rin_a and the discharge port Rout_a communicating with the same common liquid chamber SRa, and a pair of the second introduction port coupling portion Sb3 and the second discharge port coupling portion Db3 arranged in the X-axis direction communicate with each of the introduction port Rin_b and the discharge port Rout_b communicating with the same common liquid chamber SRb.

In the present embodiment, the Z-axis direction is an example of the “first direction”, and the Y-axis direction is an example of the “second direction”. The flow path member 60 is an example of the “flow path structure body”. In the present embodiment, any one of the two head chips 44 is an example of the “first head chip”, and the nozzle row L of the first head chip and the common liquid chamber SR communicating with the nozzle row L are examples of the “first nozzle group” and the “first common liquid chamber portion”.

In addition, any one of the head chips 44 other than the first head chip of the two head chips 44 is an example of the “second head chip”, and the nozzle row L of the second head chip and the common liquid chamber SR communicating with the nozzle row L are examples of the “second nozzle group” and the “second common liquid chamber portion”.

In addition, the first supply path Sa and the first discharge path Da are examples of the “first flow path” and the “second flow path”, and the second supply path Sb and the second discharge path Db are examples of the “first flow path” and the second flow path. In addition, the first supply common portion Sa2 and the first discharge common portion Da2 are examples of the “first common portion” and the “second common portion”, and the second supply common portion Sb2 and the second discharge common portion Db2 are examples of the “first common portion” and the “second common portion”.

Any one of the flexible members 157 and 158 is an example of the “first flexible member”, and the other is an example of the “second flexible member”.

Any one of the compliance spaces 160 and 162 is an example of the “common first compliance space”.

Any one of the flow path substrates 83 and 85 is an example of the “first flow path substrate”, the other is an example of the “second flow path substrate”, and the flow path substrate 84 is an example of the “third flow path substrate”.

Specifically, when the head chip 44A is an example of the “first head chip”, the head chip 44B is an example of the “second head chip”, the nozzle row La1 of the head chip 44A and the common liquid chamber SRa1 communicating with the nozzle row La1 are examples of the “first nozzle group” and the “first common liquid chamber portion”, the nozzle row La2 of the head chip 44B and the common liquid chamber SRa2 communicating with the nozzle row La2 are examples of the “second nozzle group” and the “second common liquid chamber portion”, the first supply path Sa is an example of the “first flow path”, the first supply common portion Sa2 is an example of the “first common portion”, the first discharge path Da is an example of the “second flow path”, the first discharge common portion Da2 is an example of the “second common portion”, the flexible member 157 is an example of the “first flexible member”, and the flexible member 158 is an example of the “second flexible member”. Furthermore, the compliance space 160 is an example of the “common first compliance space”. The flow path substrate 83 in the present embodiment is an example of the “first flow path substrate”, the flow path substrate 85 is an example of the “second flow path substrate”, and the flow path substrate 84 is an example of the “third flow path substrate”.

### Fourth Embodiment

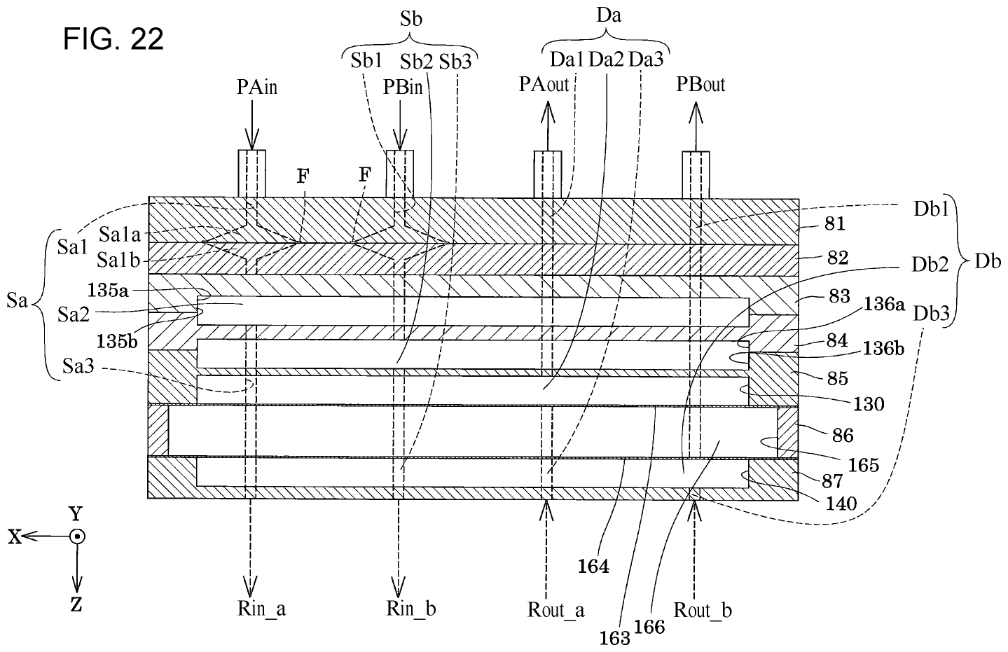

FIG. 22 is a cross-sectional view of a main portion of a flow path member 60 according to a fourth embodiment of the present disclosure. The same reference signs will be given to the same members as those in the above-described embodiment, and the repetitive description thereof will be omitted. Although not illustrated, a head chip 44 has the same configuration as that of the above-described first embodiment.

As illustrated in the drawing, the flow path member 60 in the present embodiment includes flow path substrates 81 to 87. The flow path member 60 includes a first supply path Sa and a second supply path Sb, and a first discharge path Da and a second discharge path Db.

The first supply path Sa includes a first introduction portion Sa1, a first supply common portion Sa2 communicating with the first introduction portion Sa1, and two first introduction port coupling portions Sa3 communicating with the first supply common portion Sa2.

Since the first introduction portion Sa1 is the same as that of the third embodiment described above, the description thereof will be omitted.

The first supply common portion Sa2 is defined by a first recess portion 135a for a first supply common portion and a second recess portion 135b for the first supply common portion. The first recess portion 135a for the first supply common portion has a recessed shape that is open on the surface of the flow path substrate 83 facing the +Z direction. The second recess portion 135b for the first supply common portion has a recessed shape that is open on the surface of the flow path substrate 84 facing the −Z direction. The first supply common portion Sa2 extends in the Y-axis direction.

The first introduction port coupling portion Sa3 is a flow path that couples the first supply common portion Sa2 and the introduction port Rin_a of each head chip 44, and in the present embodiment, two first introduction port coupling portions Sa3 are provided, which are the same number as the head chips 44. The first introduction port coupling portion Sa3 is a flow path provided in the flow path substrates 84 to 87, and is formed with a flow path extending in the Z-axis direction, a flow path extending along the stacked interface of each stacked flow path substrate, and the like. One end of the first introduction port coupling portion Sa3 communicates with the first supply common portion Sa2, and the other end communicates with the introduction port Rin_a via a communication path 34 (not illustrated).

The second supply path Sb has the same configuration as that of the first supply path Sa. Specifically, the second supply path Sb includes the second introduction portion Sb1, the second supply common portion Sb2 communicating with the second introduction portion Sb1, and two second introduction port coupling portions Sb3 communicating with the second supply common portion Sb2.

The second introduction portion Sb1 is the same as that of the third embodiment described above except that one end of the second introduction portion Sb1 is open on the bottom surface of a first recess portion 136a for a second supply common portion of the flow path substrate 84, and thus the repetitive description will be omitted.

The second supply common portion Sb2 is defined by the first recess portion 136a for the second supply common portion and a second recess portion 136b for the second supply common portion. The first recess portion 136a for the second supply common portion has a recessed shape that is open on the surface of the flow path substrate 84 facing the +Z direction. The second recess portion 136b for the second supply common portion has a recessed shape that is open on the surface of the flow path substrate 85 facing the −Z direction. The second supply common portion Sb2 extends in the Y-axis direction.

The second introduction port coupling portion Sb3 is a flow path that couples the second supply common portion Sb2 and the introduction port Rin_b of each head chip 44, and in the present embodiment, two second introduction port coupling portions Sb3 are provided, which are the same number as the head chips 44. The second introduction port coupling portion Sa3 is a flow path provided in the flow path substrates 85 to 87, and is formed with a flow path extending in the Z-axis direction, a flow path extending along the stacked interface of each stacked flow path substrate, and the like. One end of the second introduction port coupling portion Sb3 communicates with the second supply common portion Sb2, and the other end communicates with the introduction port Rin_b via a communication path 34 (not illustrated).

The first discharge path Da includes a first flow-out portion Da1, a first discharge common portion Da2 communicating with the first flow-out portion Da1, and two first discharge port coupling portions Da3 communicating with the first discharge common portion Da2.

The first flow-out portion Da1 is a flow path provided in the flow path substrates 81 to 85, and is formed with a flow path extending in the Z-axis direction, a flow path extending along the stacked interface of the stacked flow path substrates, and the like. One end of the first flow-out portion Da1 is open at the tip of the discharge path coupling portion PAout.

The first discharge common portion Da2 is defined by a first discharge common-portion recess portion 130 having a recessed shape that is open on the surface of the flow path substrate 85 facing the +Z direction. The first discharge common portion Da2 extends in the Y-axis direction.

A portion of the surface of the first discharge common portion Da2 in the +Z direction is defined by a flexible member 163. The flexible member 163 is held between the flow path substrates 85 and 86. The other end of the first flow-out portion Da1 communicates with the bottom surface of a first discharge common-portion recess portion 130.

The first discharge port coupling portion Da3 is a flow path that couples the first discharge common portion Da2 and the discharge port Rout_a of each head chip 44, and in the present embodiment, two first discharge port coupling portions Da3 are provided, which are the same number as the head chips 44. The first discharge port coupling portion Da3 is provided in the flow path substrates 86 and 87. The first discharge port coupling portion Da3 communicates with the first discharge common portion Da2 in a portion where one end of the first discharge port coupling portion Da3 is not defined by a flexible member 163 of the first discharge common portion Da2, that is, in a portion of the first discharge common portion Da2 defined by the flow path substrate 86. In addition, the other end of the first discharge port coupling portion Da3 communicates with the discharge port Rout_a via a communication path 34 (not illustrated).

The second discharge path Db includes a second flow-out portion Db1, a second discharge common portion Db2 communicating with the second flow-out portion Db1, and two second discharge port coupling portions Db3 communicating with the second discharge common portion Db2.

The second flow-out portion Db1 is a flow path provided in the flow path substrates 81 to 86, and is formed with a flow path extending in the Z-axis direction, a flow path extending along the stacked interface of the flow path substrate, and the like. One end of the second flow-out portion Db1 is open at the tip of the discharge path coupling portion PBout.

The second discharge common portion Db2 is defined by a second discharge common-portion recess portion 140 having a recessed shape that is open on the surface of the flow path substrate 87 facing the −Z direction. The second discharge common portion Db2 extends in the Y-axis direction.

A portion of the surface of the second discharge common portion Db2 in the −Z direction is defined by a flexible member 164. The flexible member 164 is held between the flow path substrates 86 and 87. The other end of the second flow-out portion Db1 communicates with the second discharge common portion Db2 in a portion of the second discharge common portion Db2 that is not defined by the flexible member 164, that is, in a portion of the second discharge common portion Db2 defined by the flow path substrate 86.

The second discharge port coupling portion Db3 is a flow path that couples the second discharge common portion Db2 and the discharge port Rout_b of each head chip 44, and in the present embodiment, two second discharge port coupling portions Db3 are provided, which are the same number as the head chips 44. The second discharge port coupling portion Db3 is provided in the flow path substrate 87. One end of the second discharge port coupling portion Db3 communicates with the second discharge common portion Db2, and the other end communicates with the discharge port Rout_b via a communication path 34 (not illustrated).

The flow path substrate 86 is provided with a third penetration portion 165 that penetrates in the Z-axis direction, at a position that overlaps the first discharge common portion Da2 and the second discharge common portion Db2 when viewed in the Z-axis direction. An opening of the third penetration portion 165 in the −Z direction is covered with the flexible member 163, and an opening of the third penetration portion 165 in the +Z direction is covered with the flexible member 164. As a result, a compliance space 166 is defined inside the third penetration portion 165. By providing the compliance space 166, a portion of the flexible member 163 that defines the first discharge common portion Da2 and a portion of the flexible member 164 that defines the second discharge common portion Db2 are deformable.

In a liquid ejecting head H having such a flow path member 60 in the present embodiment, it is possible to exhibit the same effect as that of the above-described embodiments.

In FIG. 22, a filter F is provided in the first introduction portion Sa1. Instead of this, a filter may be provided in the middle of each of the two first introduction port coupling portions Sa3. Similarly, instead of the filter F of the second introduction portion Sb1, a filter may be provided in the middle of each of the two second introduction port coupling portions Sb3. In such a case, in particular, the negative pressure of one head chip 44 is more likely to act on the other head chip via the first discharge path Da and the second discharge path Db than via the first supply path Sa and the second supply path Sb. Therefore, portions of the first discharge common portion Da2 and the second discharge common portion Db2, which are the common portions of the first discharge path Da and the second discharge path Db, are defined by the flexible members, and the pressure fluctuation in the first discharge common portion Da2 and the second discharge common portion Db2 is absorbed by deforming the flexible members, whereby it is possible to more effectively reduce the pressure fluctuation.

In the present embodiment, the first supply common portion Sa2, the second supply common portion Sb2, the first discharge common portion Da2, and the second discharge common portion Db2 are disposed at positions overlapping each other when viewed in the Z-axis direction. Therefore, it is possible to reduce the size of the flow path member 60 along the XY plane as compared with the case where the first supply common portion Sa2, the second supply common portion Sb2, the first discharge common portion Da2, and the second discharge common portion Db2 are disposed along the XY plane.

One compliance space 166 serves as a compliance space for deformation of the flexible member 163 and a compliance space for deformation of the flexible member 164. As a result, the size of the flow path member 60 in the Z-axis direction can be reduced as compared with the case where the compliance space is individually provided.

In the present embodiment, the Z-axis direction is an example of the “first direction”, and the Y-axis direction is an example of the “second direction”. The flow path member 60 is an example of the “flow path structure body”. In addition, when the head chip 44A is an example of the “first head chip”, the head chip 44B is an example of the “second head chip”, the nozzle row La1 of the head chip 44A and the common liquid chamber SRa1 communicating with the nozzle row La1 are examples of the “first nozzle group” and the “first common liquid chamber portion”, the nozzle row La2 of the head chip 44B and the common liquid chamber SRa2 communicating with the nozzle row La2 are examples of the “second nozzle group” and the “second common liquid chamber portion”, the nozzle row Lb1 of the head chip 44A and the common liquid chamber SRb1 communicating with the nozzle row Lb1 are examples of the “third nozzle group” and the “third common liquid chamber portion”, and the nozzle row Lb2 of the head chip 44B and the common liquid chamber SRb2 communicating with the nozzle row Lb2 are examples of the “fourth nozzle group” and the “fourth common liquid chamber portion”, the first discharge path Da is an example of the “first flow path”, the first discharge common portion Da2 is an example of the “first common portion”, the second discharge path Db is an example of the “second flow path”, the second discharge common portion Db2 is an example of the “second common portion”, the flexible member 163 is an example of the “first flexible member”, and the flexible member 164 is an example of the “second flexible member”. Furthermore, the compliance space 166 is an example of the “common first compliance space”. The flow path substrate 85 in the present embodiment is an example of the “first flow path substrate”, the flow path substrate 87 is an example of the “second flow path substrate”, and the flow path substrate 86 is an example of the “third flow path substrate”.

### Fifth Embodiment

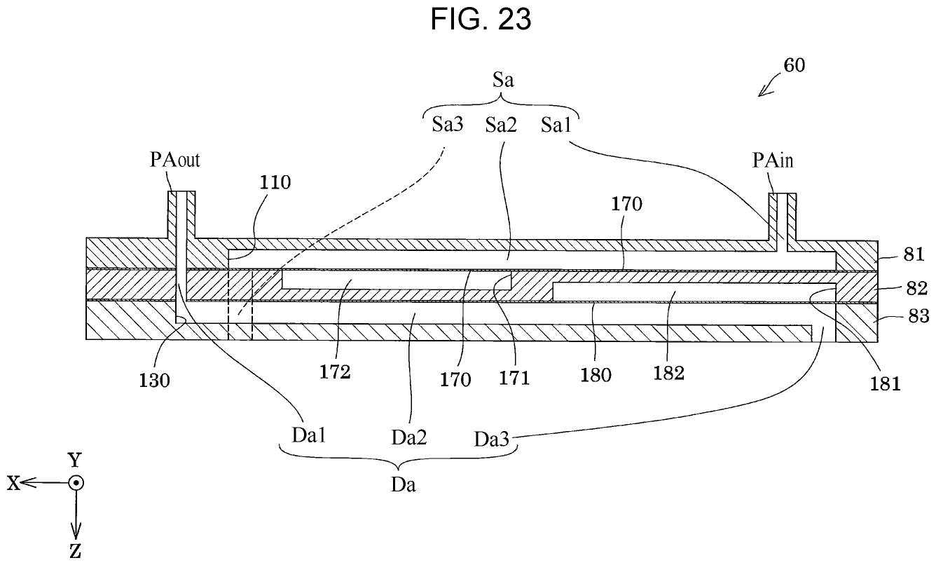

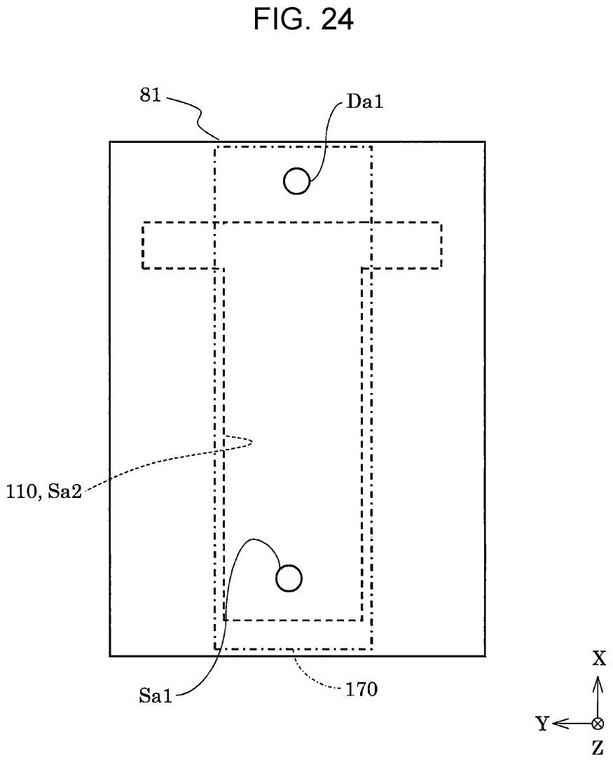

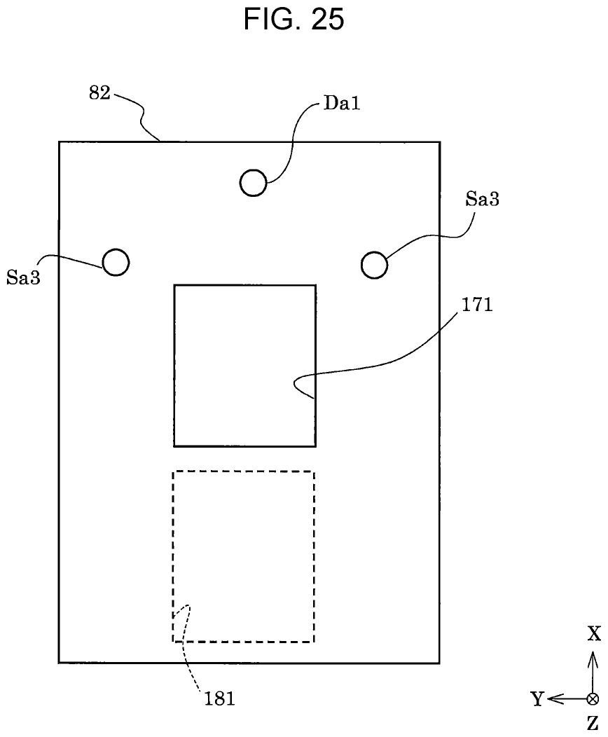

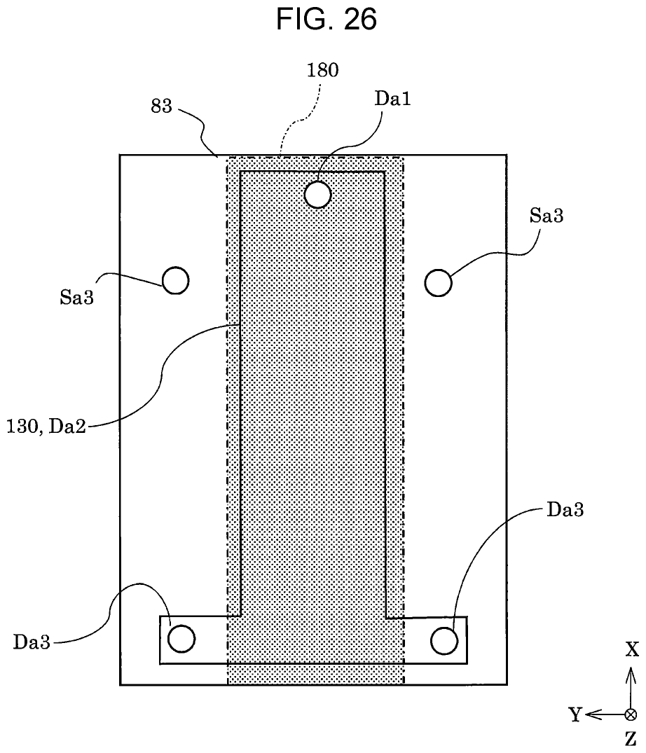

FIG. 23 is a cross-sectional view of a main portion of a flow path member 60 according to a fifth embodiment of the present disclosure. FIG. 24 is a plan view of a flow path substrate 81 when viewed in the +Z direction. FIG. 25 is a plan view of a flow path substrate 82 when viewed in the +Z direction. FIG. 26 is a plan view of a flow path substrate 83 when viewed in the +Z direction. In FIG. 24, a region in which a flexible member 170 is disposed is illustrated by a one-dot chain line, and in FIG. 26, a flexible member 180 is illustrated by hatching in which the outer periphery is surrounded by a one-dot chain line. The same reference signs will be given to the same members as those in the above-described embodiment, and the repetitive description thereof will be omitted.

As illustrated in the drawing, the flow path member 60 in the present embodiment includes flow path substrates 81 to 83. In a plan view when viewed in the +Z direction, the outer shapes of the flow path substrates 81 to 83 are substantially the same. In addition, the flow path member 60 includes a first supply path Sa and a first discharge path Da.

The first supply path Sa includes a first introduction portion Sa1, a first supply common portion Sa2, and a plurality of first introduction port coupling portions Sa3 communicating with the first supply common portion Sa2.

The first introduction portion Sa1 is a flow path provided in the flow path substrate 81 and is formed with a flow path extending in the Z-axis direction. One end of the first introduction portion Sa1 is open at the tip of the supply path coupling portion PAin.

The first supply common portion Sa2 is defined by a first supply common-portion recess portion 110 that is open on the surface of the flow path substrate 81 facing the +Z direction. The first supply common portion Sa2 extends in the X-axis direction. The other end of the first introduction portion Sa1 communicates with the bottom surface of the first supply common-portion recess portion 110.

A portion of the surface of the first supply common portion Sa2 facing the +Z direction is defined by the flexible member 170. That is, the flexible member 170 is held between the flow path substrates 81 and 82.

The first introduction port coupling portion Sa3 is a flow path that couples the first supply common portion Sa2 and the introduction port Rin_a of each head chip 44, and first introduction port coupling portions Sa3 of the same number as the head chips 44 are provided. The number of head chips 44 is not particularly limited. In the present embodiment, since two head chips 44 (not illustrated) are provided in one liquid ejecting head H, the number of the first introduction port coupling portions Sa3 is two, which is the same as the number of the head chips 44.

The first introduction port coupling portion Sa3 is provided in the flow path substrates 82 and 83. One end of the first introduction port coupling portion Sa3 communicates with the first supply common portion Sa2 in a portion of the first supply common portion Sa2 that is not defined by the flexible member 170, that is, in a portion defined by the flow path substrate 82.

The flow path substrate 82 is provided with a recess portion 171 that is open in the −Z direction, at a position overlapping the first supply common portion Sa2 when viewed in the Z-axis direction. An opening of the recess portion 171 in the −Z direction is covered with the flexible member 170 to define a compliance space 172. A portion of the flexible member 170 that defines the first supply common portion Sa2 by the compliance space 172 is deformable.

The first discharge path Da includes a first flow-out portion Da1, a first discharge common portion Da2 communicating with the first flow-out portion Da1, and a plurality of first discharge port coupling portions Da3 communicating with the first discharge common portion Da2.

The first flow-out portion Da1 is a flow path provided in the flow path substrates 81 and 82 and is formed with a flow path extending in the Z-axis direction. One end of the first flow-out portion Da1 is open at the tip of the discharge path coupling portion PAout. The other end of the first flow-out portion Da1 is open on the surface of the flow path substrate 82 facing the +Z direction, and communicates with the first discharge common portion Da2.

The first discharge common portion Da2 is defined by a first discharge common-portion recess portion 130 that is open on the surface of the flow path substrate 83 facing the −Z direction. The first discharge common portion Da2 extends in the X-axis direction.

A portion of the surface of the first discharge common portion Da2 in the −Z direction is defined by the flexible member 180. That is, the flexible member 180 is held between the flow path substrates 82 and 83. In the present embodiment, the flexible member 180 is continuously provided between the flow path substrates 82 and 83.

The first discharge port coupling portion Da3 is a flow path that couples the first discharge common portion Da2 and the discharge port Rout_a of each head chip 44, and in the present embodiment, first discharge port coupling portions Da3 of the same number as the head chips 44 are provided. In the present embodiment, since two head chips 44 (not illustrated) are provided in one liquid ejecting head H, the number of the first discharge port coupling portions Da3 is two, which is the same as the number of the head chips 44. In the present embodiment, one head chip 44 includes one common liquid chamber SR in which one introduction port Rin_a and one discharge port Rout_a communicate with each other. That is, the head chip 44 in the present embodiment has one nozzle row L.

The flow path substrate 82 is provided with a recess portion 181 that is open in the +Z direction, at a position overlapping the first discharge common portion Da2 when viewed in the Z-axis direction. That is, the first discharge common portion Da2 overlaps both the recess portion 171 and the recess portion 181 when viewed in the Z-axis direction. The first supply common portion Sa2 overlaps both the recess portion 171 and the recess portion 181 when viewed in the Z-axis direction. An opening of the recess portion 181 in the +Z direction is covered with the flexible member 180 to define a compliance space 182. A portion of the flexible member 180 that defines the first discharge common portion Da2 by the compliance space 182 is deformable. When viewed in the Z-axis direction, the compliance space 172 and the compliance space 182 defined in the same flow path substrate 82 are disposed at positions that do not overlap each other. Therefore, it is possible to reduce the number of components and reduce the cost, and it is possible to simplify the step of assembly, as compared with the case where the compliance spaces 172 and 182 are provided in different substrates. Further, by disposing the compliance spaces 172 and 182 at positions where the compliance spaces 172 and 182 do not overlap each other when viewed in the Z-axis direction, it is possible to reduce the size of the flow path member 60 in the Z-axis direction as compared with the case where the compliance spaces 172 and 182 are disposed at positions where the compliance spaces 172 and 182 overlap each other.

The recess portion 171 that defines the compliance space 172 and the recess portion 181 that defines the compliance space 182 partially overlap each other when viewed in the X-axis direction. As described above, by disposing the recess portion 171 and the recess portion 181 at positions where the recess portion 171 and the recess portion 181 partially overlap each other when viewed in the X-axis direction, it is possible to reduce the thickness of the flow path substrate 82 in the Z-axis direction and to reduce the size of the flow path member 60 in the Z-axis direction.

In the liquid ejecting head H having such a flow path member 60 in the present embodiment, the same effect as that of the above-described embodiments can be exhibited.

Further, by disposing the first supply common portion Sa2 and the first discharge common portion Da2 at positions that overlap each other when viewed in the Z-axis direction, it is possible to reduce the size of the flow path member 60 on the XY plane as compared with the case where both the first supply common portion Sa2 and the first discharge common portion Da2 are arranged on the XY plane.

Further, by disposing the first supply common portion Sa2 at a position that overlaps both the recess portion 171 and the recess portion 181 when viewed in the Z-axis direction, it is possible to reduce the size of the flow path member 60 in the XY plane and to secure the flow path cross section of the first supply common portion Sa2 to be relatively large. Similarly, by disposing the first discharge common portion Da2 at a position that overlaps both the recess portion 171 and the recess portion 181 when viewed in the Z-axis direction, it is possible to reduce the size of the flow path member 60 on the XY plane and to secure the flow path cross section of the first supply common portion Sa2 to be relatively large.

In the present embodiment, the Z-axis direction is an example of the “first direction”, and the X-axis direction is an example of the “second direction”. The flow path member 60 is an example of the “flow path structure body”. In the present embodiment, any one of the two head chips 44 is an example of the “first head chip”, and the nozzle row L of the first head chip and the common liquid chamber SR communicating with the nozzle row L are examples of the “first nozzle group” and the “first common liquid chamber portion”. The other of the two head chips 44 is an example of the “second head chip”, and the nozzle row L of the second head chip and the common liquid chamber SR communicating with the nozzle row L are examples of the “second nozzle group” and the “second common liquid chamber portion”.

In addition, any one of the first supply path Sa, the first supply common portion Sa2, the flow path substrate 81, the flexible member 170, the recess portion 171, and the compliance space 172, and the first discharge path Da, the first discharge common portion Da2, the flow path substrate 83, the flexible member 180, the recess portion 181, and the compliance space 182 are examples of the “first flow path”, the “first common portion”, the “first flow path substrate”, the “first flexible member”, the “first recess portion”, and the “first compliance space”, and the other is an example of the “second flow path”, the “second common portion”, the “second flow path substrate”, the “second recess portion”, and the “second compliance space”. The flow path substrate 82 is an example of the “third flow path substrate”, and any one of the surface of the flow path substrate 82 facing the −Z direction or the surface of the flow path substrate 82 facing the +Z direction is an example of a “first surface”, and the other is an example of a “second surface”.

### Other Embodiments

Although each embodiment of the present disclosure was described above, the basic configuration of the present disclosure is not limited to the above-described one.

In the first to third, and fifth embodiments described above, the portions of the first supply common portion Sa2 of the first supply path Sa, the second supply common portion Sb2 of the second supply path Sb, the first discharge common portion Da2 of the first discharge path Da, and the second discharge common portion Db2 of the second discharge path Db, which are the flow paths communicating with the plurality of head chips 44 in common, are defined by the respective flexible members, but the present disclosure is not particularly limited thereto. Since the first supply path Sa and the second supply path Sb are provided with the filter F, when the ink is discharged from the head chip 44, the pressure fluctuation on the first discharge path Da and the second discharge path Db side becomes larger than that on the first supply path Sa and the second supply path Sb. Therefore, it is sufficient that portions of at least the first discharge common portion Da2 of the first discharge path Da and the second discharge common portion Db2 of the second discharge path Db are defined by the flexible members. That is, the flexible members that define the portions of the first supply common portion Sa2 of the first supply path Sa and the second supply common portion Sb2 of the second supply path Sb do not need to be provided. Conversely, only the flexible members that define the portions of the first supply common portion Sa2 of the first supply path Sa and the second supply common portion Sb2 of the second supply path Sb may be provided, and the flexible members that define the portions of the first discharge common portion Da2 of the first discharge path Da and the second discharge common portion Db2 of the second discharge path Db do not need to be provided.

In addition, the head chip 44 in each of the above-described embodiments exemplifies a configuration in which the ink circulates through the common liquid chamber SR, but the present disclosure is not particularly limited thereto. For example, the pressure chamber SC may be configured to circulate the ink. That is, a configuration in which the head chip 44 is provided with a first common liquid chamber communicating with one end of the pressure chamber SC and a second common liquid chamber communicating with the other end of the pressure chamber SC, and the ink from the first common liquid chamber is supplied to the pressure chamber SC, the ink in the pressure chamber SC is discharged to the second common liquid chamber, and the ink is collected from the second common liquid chamber to the outside may be adopted. In this case, the entirety of the first common liquid chamber and the second common liquid chamber corresponds to the “common liquid chamber portion”.

The method of fixing the flexible member to the flow path member 60 in the above-described embodiments is not particularly limited, and examples thereof include bonding with an adhesive, welding with heat, ultrasonic waves, or the like.

For example, in the above-described embodiments, description is made by using a thin film type piezoelectric actuator 484 as a drive element that causes the pressure change in the pressure chamber SC, but the present disclosure is not particularly limited thereto. For example, a thick film type piezoelectric actuator formed by a method such as sticking a green sheet, a longitudinal vibration type piezoelectric actuator that alternately stacks a piezoelectric material and an electrode forming material and expands and contracts in the axial direction, or the like can be used as the drive element. In addition, as the drive element, for example, an element in which a heat generating element is disposed in the pressure chamber SC to eject the droplets from the nozzle N by bubbles generated due to the heat of the heat generating element, or a so-called capacitive actuator that generates static electricity between a diaphragm and an electrode, deforms the diaphragm by the electrostatic force, and ejects the droplets from the nozzle N can be used.

In addition, in the liquid ejecting apparatus 1 described above, the case where the liquid ejecting head H is mounted on the holding body 6a and moves in the main scanning direction is described as an example, but the present disclosure is not particularly limited thereto. The present disclosure can be applied to a so-called line type recording apparatus in which the liquid ejecting head H is fixed and printing is performed only by moving the medium S such as paper in the sub-scanning direction.

### Supplementary Notes

From the embodiments exemplified above, for example, the following configuration can be ascertained.

According to a first aspect that is the preferred aspect, a liquid ejecting head includes a first head chip including a first nozzle group and a first common liquid chamber portion communicating with the first nozzle group, a second head chip including a second nozzle group and a second common liquid chamber portion communicating with the second nozzle group, and a flow path structure body including a plurality of flow path substrates stacked in a first direction, and including a first flow path having a first common portion that communicates with the first common liquid chamber portion and the second common liquid chamber portion and extends in a second direction perpendicular to the first direction, and a first flexible member defining a portion of the first common portion. With this configuration, by deforming the first flexible member, it is possible to reduce the negative pressure of the first common portion generated by ejecting the liquid from one of the first nozzle group and the second nozzle group, and alleviate the water hammer action on the other, and thus it is possible to suppress the discharge abnormality from the other nozzle group.

In a second aspect that is a specific example of the first aspect, the flow path structure body includes a second flow path having a second common portion that communicates with the first common liquid chamber portion and the second common liquid chamber portion and extends in the second direction, and a second flexible member defining a portion of the second common portion, and the plurality of flow path substrates include a first flow path substrate that defines the second common portion and defines a first compliance space together with the first flexible member, and a second flow path substrate that defines the first common portion and defines a second compliance space together with the second flexible member. With this configuration, in a plan view when viewed in the first direction, by disposing the flow path and the compliance space in the same flow path substrate so as not to overlap each other, it is possible to secure the cross-sectional area of the flow path to be large and to suppress the size of the flow path structure body in the first direction.

In a third aspect that is a specific example of the second aspect, the plurality of flow path substrates include a third flow path substrate that is disposed between the first flow path substrate and the second flow path substrate and defines the first common portion and the second common portion.

In a fourth aspect that is a specific example of the first aspect, the flow path structure body includes a second flexible member defining a portion of the first common portion, and the plurality of flow path substrates include a first flow path substrate that defines a first compliance space together with the first flexible member, a second flow path substrate that defines a second compliance space together with the second flexible member, and a third flow path substrate that is disposed between the first flow path substrate and the second flow path substrate and defines the first common portion together with the first flexible member and the second flexible member. With this configuration, by providing the flexible members on both sides of the third flow path substrate in the first direction, it is possible to secure the compliance capacity to be large, and to further reduce the water hammer action.

In a fifth aspect that is a specific example of the first aspect, the flow path structure body includes a second flow path having a second common portion that communicates with the first common liquid chamber portion and the second common liquid chamber portion and extends in the second direction, and a second flexible member defining a portion of the second common portion, the first common portion and the second common portion have at least an overlapping portion when viewed in the first direction, and the first flexible member and the second flexible member define a common first compliance space. With this configuration, the structure of the flow path structure body can be simplified and the size reduction can be achieved by sharing the compliance space for deformation of the first flexible member and the compliance space for deformation of the second flexible member.

In a sixth aspect that is a specific example of the fifth aspect, the plurality of flow path substrates include a first flow path substrate that defines the first common portion, a second flow path substrate that defines the second common portion, and a third flow path substrate that is disposed between the first flow path substrate and the second flow path substrate and defines the first compliance space together with the first flexible member and the second flexible member.

In a seventh aspect that is a specific example of the first aspect, the first head chip includes a third nozzle group and a third common liquid chamber portion communicating with the third nozzle group, the second head chip includes a fourth nozzle group and a fourth common liquid chamber portion communicating with the fourth nozzle group, the flow path structure body includes a third flow path having a third common portion that communicates with the third common liquid chamber portion and the fourth common liquid chamber portion and extends in the second direction, and a second flexible member defining a portion of the third common portion, and the plurality of flow path substrates include a first flow path substrate that defines the first common portion, a second flow path substrate that defines the third common portion, and a third flow path substrate that is disposed between the first flow path substrate and the second flow path substrate and defines a first compliance space together with the first flexible member and the second flexible member. With this configuration, the structure can be simplified and the size reduction can be achieved by sharing the compliance spaces for the first common portion and the third common portion.

In an eighth aspect that is a specific example of the seventh aspect, the first flow path is a flow path for collecting a liquid from the first common liquid chamber portion and the second common liquid chamber portion, and the third flow path is a flow path for collecting a liquid from the third common liquid chamber portion and the fourth common liquid chamber portion.

In a ninth aspect that is a specific example of the first aspect, the flow path structure body includes a second flow path having a second common portion that communicates with the first common liquid chamber portion and the second common liquid chamber portion and extends in the second direction, and a second flexible member defining a portion of the second common portion, the plurality of flow path substrates include a first flow path substrate that defines the first common portion, a second flow path substrate that defines the second common portion, and a third flow path substrate disposed between the first flow path substrate and the second flow path substrate, and the third flow path substrate includes a first surface having a first recess portion that defines a first compliance space with the first flexible member, and a second surface that is a surface opposite to the first surface and has a second recess portion that defines a second compliance space with the second flexible member. With this configuration, the number of components can be reduced and the size reduction can be achieved, by forming the first recess portion and the second recess portion for defining the compliance spaces on both sides of the third flow path substrate in the first direction.

In a tenth aspect that is a specific example of the ninth aspect, the first recess portion and the second recess portion partially overlap each other when viewed in the second direction. With this configuration, it is possible to reduce the size of the flow path structure body in the first direction.

In an eleventh aspect that is a specific example of the tenth aspect, the first common portion overlaps both the first recess portion and the second recess portion when viewed in the first direction. With this configuration, it is possible to reduce the size of the flow path structure body in the direction perpendicular to the first direction, and to secure the flow path cross-sectional area to be large.

In a twelfth aspect that is a specific example of the second, fifth, and ninth aspects, the first flow path is a flow path for supplying a liquid to the first common liquid chamber portion and the second common liquid chamber portion, and the second flow path is a flow path for collecting a liquid from the first common liquid chamber portion and the second common liquid chamber portion.

According to a thirteenth aspect that is the preferred aspect, a liquid ejecting apparatus includes the liquid ejecting head according to the first aspect, and a liquid storage portion that supplies the liquid to the liquid ejecting head. With this configuration, it is possible to suppress the discharge abnormality of the droplets from the nozzle group and improve the printing quality.

What is claimed is:

1. A liquid ejecting head comprising:
a first head chip including a first nozzle group and a first common liquid chamber portion communicating with the first nozzle group;
a second head chip including a second nozzle group and a second common liquid chamber portion communicating with the second nozzle group; and
a flow path structure body including a plurality of flow path substrates stacked in a first direction, and including a first flow path having a first common portion that communicates with the first common liquid chamber portion and the second common liquid chamber portion and extends in a second direction perpendicular to the first direction, and a first flexible member defining a portion of the first common portion.

2. The liquid ejecting head according to claim 1, wherein
the flow path structure body includes a second flow path having a second common portion that communicates with the first common liquid chamber portion and the second common liquid chamber portion and extends in the second direction, and a second flexible member defining a portion of the second common portion, and
the plurality of flow path substrates include
a first flow path substrate that defines the second common portion and defines a first compliance space together with the first flexible member, and
a second flow path substrate that defines the first common portion and defines a second compliance space together with the second flexible member.

3. The liquid ejecting head according to claim 2, wherein
the plurality of flow path substrates include a third flow path substrate that is disposed between the first flow path substrate and the second flow path substrate and defines the first common portion and the second common portion.

4. The liquid ejecting head according to claim 1, wherein
the flow path structure body includes a second flexible member defining a portion of the first common portion, and
the plurality of flow path substrates include
a first flow path substrate that defines a first compliance space together with the first flexible member,
a second flow path substrate that defines a second compliance space together with the second flexible member, and
a third flow path substrate that is disposed between the first flow path substrate and the second flow path substrate and defines the first common portion together with the first flexible member and the second flexible member.

5. The liquid ejecting head according to claim 1, wherein
the flow path structure body includes a second flow path having a second common portion that communicates with the first common liquid chamber portion and the second common liquid chamber portion and extends in the second direction, and a second flexible member defining a portion of the second common portion,
the first common portion and the second common portion have at least an overlapping portion when viewed in the first direction, and
the first flexible member and the second flexible member define a common first compliance space.

6. The liquid ejecting head according to claim 5, wherein
the plurality of flow path substrates include
a first flow path substrate that defines the first common portion,
a second flow path substrate that defines the second common portion, and
a third flow path substrate that is disposed between the first flow path substrate and the second flow path substrate and defines the first compliance space together with the first flexible member and the second flexible member.

7. The liquid ejecting head according to claim 1, wherein
the first head chip includes a third nozzle group and a third common liquid chamber portion communicating with the third nozzle group,
the second head chip includes a fourth nozzle group and a fourth common liquid chamber portion communicating with the fourth nozzle group,
the flow path structure body includes a third flow path having a third common portion that communicates with the third common liquid chamber portion and the fourth common liquid chamber portion and extends in the second direction, and a second flexible member defining a portion of the third common portion, and
the plurality of flow path substrates include
a first flow path substrate that defines the first common portion,
a second flow path substrate that defines the third common portion, and
a third flow path substrate that is disposed between the first flow path substrate and the second flow path substrate and defines a first compliance space together with the first flexible member and the second flexible member.

8. The liquid ejecting head according to claim 7, wherein
the first flow path is a flow path for collecting a liquid from the first common liquid chamber portion and the second common liquid chamber portion, and
the third flow path is a flow path for collecting a liquid from the third common liquid chamber portion and the fourth common liquid chamber portion.

9. The liquid ejecting head according to claim 1, wherein
the flow path structure body includes a second flow path having a second common portion that communicates with the first common liquid chamber portion and the second common liquid chamber portion and extends in the second direction, and a second flexible member defining a portion of the second common portion,
the plurality of flow path substrates include
a first flow path substrate that defines the first common portion,
a second flow path substrate that defines the second common portion, and
a third flow path substrate disposed between the first flow path substrate and the second flow path substrate, and
the third flow path substrate includes a first surface having a first recess portion that defines a first compliance space with the first flexible member, and a second surface that is a surface opposite to the first surface and has a second recess portion that defines a second compliance space with the second flexible member.

10. The liquid ejecting head according to claim 9, wherein
the first recess portion and the second recess portion partially overlap each other when viewed in the second direction.

11. The liquid ejecting head according to claim 10, wherein
the first common portion overlaps both the first recess portion and the second recess portion when viewed in the first direction.

12. The liquid ejecting head according to claim 2, wherein
the first flow path is a flow path for supplying a liquid to the first common liquid chamber portion and the second common liquid chamber portion, and
the second flow path is a flow path for collecting a liquid from the first common liquid chamber portion and the second common liquid chamber portion.

13. The liquid ejecting head according to claim 5, wherein
the first flow path is a flow path for supplying a liquid to the first common liquid chamber portion and the second common liquid chamber portion, and
the second flow path is a flow path for collecting a liquid from the first common liquid chamber portion and the second common liquid chamber portion.

14. The liquid ejecting head according to claim 9, wherein
the first flow path is a flow path for supplying a liquid to the first common liquid chamber portion and the second common liquid chamber portion, and
the second flow path is a flow path for collecting a liquid from the first common liquid chamber portion and the second common liquid chamber portion.

15. A liquid ejecting apparatus comprising:
the liquid ejecting head according to claim 1; and
a liquid storage portion that supplies a liquid to the liquid ejecting head.
